(19) United States
(12) Patent Application Publication
(10) Pub. No.: US 2012/0156444 A1
(43) Pub. Date: Jun. 21, 2012

(54) TRANSFER MEDIUM, PRODUCTION METHOD THEREOF, AND TRANSFERRED MATTER

(75) Inventors: Kiyohiko TAKEMOTO, Matsumoto-shi (JP); Kazuaki TSUKIANA, Azumino-shi (JP); Masakazu OHASHI, Matsumoto-shi (JP)

(73) Assignee: Seiko Epson Corporation, Tokyo (JP)

(21) Appl. No.: 13/326,785

(22) Filed: Dec. 15, 2011

(30) Foreign Application Priority Data
Dec. 15, 2010 (JP) 2010-279781
Dec. 15, 2010 (JP) 2010-279794

(51) Int. Cl. B41J 2/015; B32B 3/10

(52) U.S. Cl. 428/195.1; 347/21

(57) ABSTRACT

A production method of a transfer medium includes: forming a colored layer on a base material by discharging ink from an ink jet head toward the base material; and forming an adhesive layer on the colored layer by discharging an adhesive liquid from the ink jet head toward the colored layer.

The entire disclosure of Japanese Application No.: 2010-279781 filed on Dec. 15, 2010 and 2010-279794 filed on Dec. 15, 2010 are expressly incorporated by reference herein.

### BACKGROUND

1. Technical Field

The present invention relates to a transfer medium, a production method thereof, and a transferred matter.

2. Related Art

Hitherto, a transfer medium that transfers, onto a medium to be transferred, characters and other image patterns formed by adhering ink onto a base material is known. For the transfer medium, for example, as disclosed in JP-A-7-314879, a technique for applying an adhesive liquid onto a corresponding pattern using, for example, a screen printing plate according to the pattern shape is known.

However, in a case where an image pattern or an adhesive liquid pattern is formed using a flexographic or gravure printing plate and the like other than the screen printing plate, production costs in high-mix low-volume production of transfer media are increased. Thereby, in order to suppress the production costs in high-mix low-volume production of transfer media so as to be low, a method of producing a transfer medium by discharging ink and an adhesive liquid from an ink jet head to be adhered to a base material thereby sequentially forming a colored layer with the ink and an adhesive layer with the adhesive liquid on the base material is considered.

The ink discharged from the ink jet head to form the colored layer and the adhesive liquid discharged from the ink jet head to form the adhesive layer require the following characteristics.

First, excellent discharge stability of the ink and the adhesive liquid is required during driving at a high frequency by the ink jet head.

Second, in a process for forming the pattern of the adhesive layer by adhering the adhesive liquid onto the pattern of the colored layer, obtaining an image with high resolution without causing the flow or collapse of the colored layer pattern is required.

Third, distributing thermoplastic resin included in the adhesive layer on the colored layer pattern with good efficiency, not generating transfer defects of minute characters or transfer unevenness of the image in use as a transfer medium, and excellent transferability are required.

Fourth, excellent adhesiveness between a medium to be transferred (target) or the colored layer and the adhesive layer after transfer is required.

Fifth, excellent blocking resistance of the transfer medium without tack and thus easy storage thereof in a warehouse are required.

### SUMMARY

An advantage of some aspects of the invention is that it solves at least one of the problems. Furthermore, the advantage provides a production method of a transfer medium in which discharge stability is excellent when ink for formation of a colored layer and an adhesive liquid for formation of an adhesive layer are discharged from an ink jet head, the pattern of the colored layer can be obtained with high resolution, and transferability, adhesiveness after transfer, and blocking resistance are excellent, a transfer medium obtained by the production method, and a transferred matter obtained by transfer of the transfer medium.

The inventors studied intensively to solve the problems. As a result, according to production methods of a transfer medium related to an aspect A and/or an aspect B, the inventors found production methods that can solve the problems and completed the aspects of the invention.

In the production method of a transfer medium related to the aspect A, that is, in a production method of a transfer medium in which a colored layer is formed by discharging ink and an adhesive layer is formed by discharging an adhesive liquid, the adhesive liquid is an aqueous liquid containing a thermoplastic resin in an emulsion form having a glass-transition temperature of equal to or higher than 0° C. and equal to or lower than 60° C.

In addition, in the production method of a transfer medium related to the aspect B, that is, in a production method of a transfer medium in which a colored layer is formed by discharging ink and an adhesive layer is formed by discharging an adhesive liquid, the ink is an aqueous pigment ink, a non-aqueous pigment ink, or a UV-curable pigment ink, the adhesive liquid is an aqueous liquid containing a thermoplastic resin in an emulsion form having an average particle size of smaller than 1 μm, and the thickness of the adhesive layer is smaller than the thickness of the colored layer.

That is, the aspects of the invention are as follows.

[1] According to an aspect of the invention, there is provided a production method of a transfer medium including: forming a colored layer on a base material by discharging ink from an ink jet head toward the base material; and forming an adhesive layer on the colored layer by discharging an adhesive liquid from the ink jet head toward the colored layer, wherein the adhesive liquid is an aqueous liquid containing a thermoplastic resin in an emulsion form having a glass-transition temperature of equal to or higher than 0° C. and equal to or lower than 60° C.

[2] In the production method of a transfer medium according to [1], the ink may be an aqueous pigment ink, a non-aqueous pigment ink, or a UV-curable pigment ink.

[3] In the production method of a transfer medium according to [1] or [2], the forming of the colored layer may include evaporating a liquid component contained in the ink discharged and adhered to the base material so as to satisfy the following any of (1), (2), and (3): (1) in a case where the ink is the aqueous pigment ink, 65 to 95 mass % of the liquid component contained in the ink is evaporated, (2) in a case where the ink is the non-aqueous pigment ink, 50 to 90 mass % of the liquid component contained in the ink is evaporated, and (3) in a case where the ink is the UV-curable pigment ink, 40 to 70 mass % of the liquid component contained in the ink is evaporated.

[4] In the production method of a transfer medium according to any of [1] to [3], the aqueous pigment ink or the non-aqueous pigment ink from among the inks may contain a water-soluble organic solvent having a boiling point of equal to or higher than 70° C. and equal to or lower than 250° C. at 1 atm, and the water-soluble organic solvent may be an aqueous liquid containing one or more kinds selected from the group consisting of lactam, carboxylic acid ester, alkylene glycol ether, and alcohol.

[5] In the production method of a transfer medium according to any of [1] to [4], the adhesive liquid may contain a water-soluble organic solvent having a boiling point of equal to or higher than 70° C. and equal to or lower than 250° C. at 1 atm, and the water-soluble organic solvent is an aqueous liquid containing one or more kinds selected from the group consisting of lactam, carboxylic acid ester, alkylene glycol ether, and alcohol.

[6] In the production method of a transfer medium according to any of [1] to [5], the base material may be metal, plastic, or paper.

[7] According to another aspect of the invention, there is provided a transfer medium obtained by the production method according to any of [1] to [6].

[8] According to still another aspect of the invention, there is provided a transferred matter obtained by transferring the transfer medium according to [7] onto a medium to be transferred.

[9] According to still another aspect of the invention, there is provided a production method of a transfer medium including: forming a colored layer on a base material by discharging ink from an ink jet head toward the base material; and forming an adhesive layer on the colored layer by discharging an adhesive liquid from the ink jet head toward the colored layer, wherein the adhesive liquid is an aqueous liquid containing a thermoplastic resin in an emulsion form having an average particle size of smaller than 1 μm, and a thickness of the adhesive layer is smaller than a thickness of the colored layer.

[10] In the production method of a transfer medium according to [9], the ink may be an aqueous pigment ink, a non-aqueous pigment ink, or a UV-curable pigment ink.

[11] In the production method of a transfer medium according to [9] or [10], the forming of the colored layer may include evaporating a liquid component contained in the ink discharged and adhered to the base material so as to satisfy the following any of (1), (2), and (3): (1) in a case where the ink is the aqueous pigment ink, 65 to 95 mass % of the liquid component contained in the ink is evaporated, (2) in a case where the ink is the non-aqueous pigment ink, 50 to 90 mass % of the liquid component contained in the ink is evaporated, and (3) in a case where the ink is the UV-curable pigment ink, 40 to 70 mass % of the liquid component contained in the ink is evaporated.

[12] In the production method of a transfer medium according to any of [9] to [11], the aqueous pigment ink or the non-aqueous pigment ink from among the inks may contain a water-soluble organic solvent having a boiling point of equal to or higher than 70° C. and equal to or lower than 250° C. at 1 atm, and the water-soluble organic solvent may be an aqueous liquid containing one or more kinds selected from the group consisting of lactam, carboxylic acid ester, alkylene glycol ether, and alcohol.

[13] In the production method of a transfer medium according to any of [9] to [12], the adhesive liquid may contain a water-soluble organic solvent having a boiling point of equal to or higher than 70° C. and equal to or lower than 250° C. at 1 atm, and the water-soluble organic solvent may be an aqueous liquid containing one or more kinds selected from the group consisting of lactam, carboxylic acid ester, alkylene glycol ether, and alcohol.

[14] The production method of a transfer medium according to any of [9] to [13], the base material may be metal, plastic, or paper.

[15] According to still another aspect of the invention, there is provided a transfer medium obtained by the production method according to any of [9] to [14].

[16] According to still another aspect of the invention, there is provided a transferred matter obtained by transferring the transfer medium according to [15] onto a medium to be transferred.

[17] In the production method according to [1], the adhesive liquid may be an aqueous liquid containing a thermoplastic resin in an emulsion form having an average particle size of smaller than 1 μm, and a thickness of the adhesive layer may be smaller than a thickness of the colored layer.

### BRIEF DESCRIPTION OF THE DRAWINGS

The invention will be described with reference to the accompanying drawings, wherein like numbers reference like elements.

FIG. 1 is a side view schematically showing the entirety of a transfer medium production apparatus used in a first aspect of a production method according to an embodiment of the invention.

FIG. 2 is a side view schematically showing an image forming unit of the transfer medium production apparatus used in the first aspect of the production method according to the embodiment of the invention.

FIG. 3 is a schematic diagram showing a nozzle formation surface of an ink jet head.

FIG. 4 is a block diagram of a control configuration.

FIG. 5 is a schematic plan view of a transfer medium.

FIGS. 6A to 6D show cross-sections taken along the lines VIA-VIA, VIB-VIB, VIC-VIC, and VID-VID in FIG. 5 and are cross-sectional views of production processes of the transfer medium.

FIG. 7 is a side view schematically showing the entirety of a transfer medium production apparatus used in a second aspect of the production method according to the embodiment of the invention.

FIG. 8 is a side view schematically showing an image forming unit of the transfer medium production apparatus used in the second aspect of the production method according to the embodiment of the invention.

### DESCRIPTION OF EXEMPLARY EMBODIMENTS

Hereinafter, embodiments for embodying the invention will be described in detail. In addition, the invention is not limited to the following embodiments and can be modified in various forms without departing from the spirit and scope thereof.

In the specification, “discharge stability” refers to a property of always stably discharging droplets of ink or an adhesive liquid from nozzles without clogging of the nozzles. “Transferability” refers to a property of requiring a low energy to transfer a colored layer onto a medium to be transferred (target) from a transfer medium. The energy is dependent on one or more of temperature, pressure, and time during transfer, and it is said that transferability is good when at least one of a low temperature, a low pressure, and a short time is achieved. “Adhesiveness” refers to a property of causing the adhesion strength of the colored layer transferred onto the medium to be transferred to be excellent.

In the specification, “no tack” (tack-free) refers to scratch marks not being generated during rubbing with a cotton swab. More specifically, this refers to a property of being evaluated by a time taken, when a surface (a surface on the side with an adhesive layer) of the transfer medium is touched by a finger, until the surface is not adhered to the finger due to the viscosity (tack) of the surface. “Blocking resistance” refers to a property of not generating a phenomenon in which, when a transfer medium is wound around a paper tube using a winder, an adhesive component sticks to a contact surface (the rear surface of the transfer medium) and thus the transfer medium cannot be wound out, or the colored layer or an adhesive layer remains on the rear surface of the transfer medium even when the transfer medium is wound out. “Blocking resistance is excellent” refers to winding of the transfer medium using the winder is performed without any problems because there is no stickiness on the surface of the transfer medium.

In the specification, “(meth)acryl” means “acryl” and “methacryl” corresponding thereto, and “(meth)acrylate” means “acrylate” and “methacrylate” corresponding thereto.

In the specification, “solid content” means a material in a solid state under a condition of 1 atm and 25° C.

In addition, in the specification, “intermediate boiling point” means that a boiling point is equal to or higher than 70° C. and equal to or less than 250° C. at 1 atm.

In addition, in the specification, “base material” means a support body used for transferring patterns of a colored layer and an adhesive layer. “Transfer medium” is a medium at least including a base material, a colored layer, and an adhesive layer, and means a medium of a transfer source for transfer onto a medium to be transferred. “Medium to be transferred” means a medium of a transfer destination on which at least the colored layer and the adhesive layer are transferred from the transfer medium, that is, a target.

In addition, in the specification, “image” has a meaning including characters, and “transfer” has a meaning including joining.

In addition, in the specification, “thermal conduction type” refers to a method of transferring heat from a high-temperature part to a low-temperature part through the inner part of an object. That is, the thermal conduction type is a method in which conduction of heat to a base material side is made as a high-temperature object comes into contact with the base material. “Convection type” refers to a method of transferring heat by a fluid such as gas or liquid.

### Production Method of Transfer Medium

An embodiment of the invention is related to a production method of a transfer medium. In the production method, a colored layer obtained by discharging ink onto a base material (colored layer forming process) and an adhesive layer obtained by discharging an adhesive liquid onto the corresponding colored layer (adhesive layer forming process) are made, thereby producing a transfer medium for transferring an image onto a medium to be transferred.

Here, as the ink, an aqueous pigment ink, a non-aqueous pigment ink, or a UV-curable pigment ink (any of the aqueous pigment ink, the non-aqueous pigment ink, and the UV-curable pigment ink) is preferably used. However, a transfer medium production apparatus used for producing a transfer medium is different depending on ink type. Therefore, a transfer medium production apparatus for each ink type will be described as follows.

### Transfer Medium Production Apparatus for Aqueous Pigment Ink or Non-Aqueous Pigment Ink

A first aspect of this embodiment relates to a production method using a transfer medium production apparatus suitable for a case where an aqueous pigment ink or a non-aqueous pigment ink is used as the ink.

### 1. Apparatus Configuration

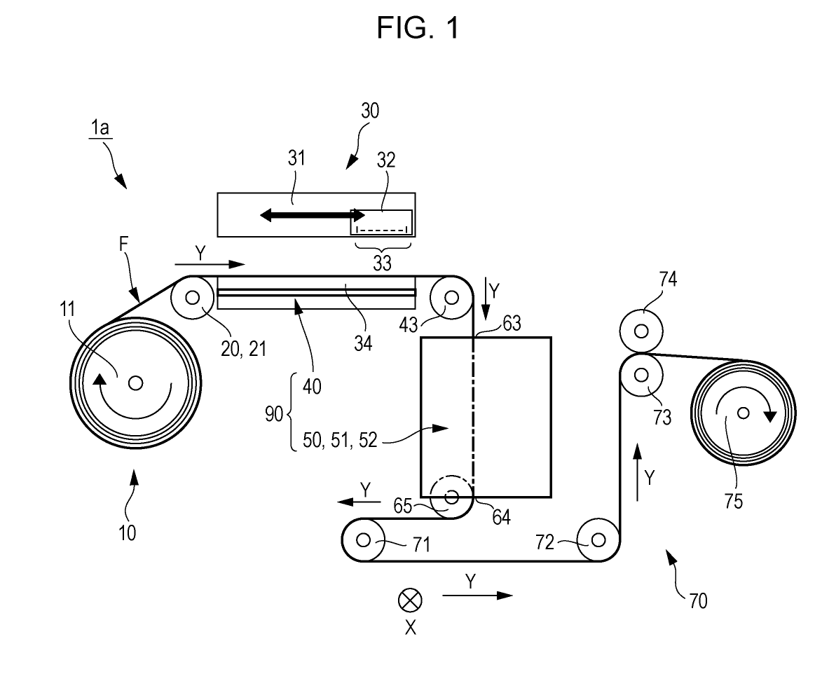

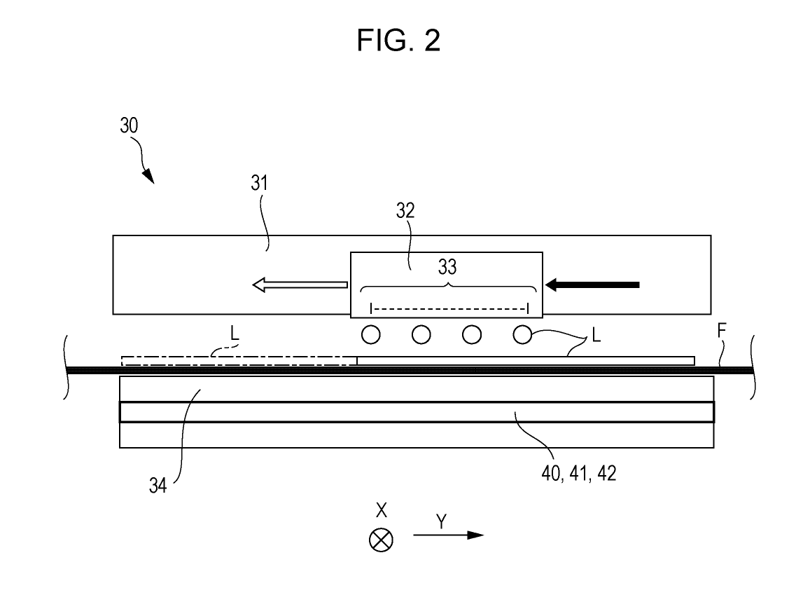

FIG. 1 is a side view schematically showing the entirety of a transfer medium production apparatus 1a used in the first aspect of this embodiment. FIG. 2 is a side view schematically showing an image forming unit 30 of the transfer medium production apparatus 1a.

As shown in FIG. 1, the transfer medium production apparatus 1a includes a feeding unit 10 of a base material F, a transporting unit 20, the image forming unit 30, a drying device 90, and a discharge unit 70. Of these, the drying device 90 has a first drying unit 40 that performs a first drying process described later and a second drying unit 50 that performs a second drying process.

The feeding unit 10 is provided to feed the base material F having a roll form to the transporting unit 20. Specifically, the feeding unit 10 has a roll medium holder 11, and the roll medium holder 11 holds the base material F having the roll form. In addition, the feeding unit 10 is configured to feed the base material F to the transporting unit 20 on the downstream side in a feeding direction by turning the base material F having the roll form.

The transporting unit 20 is provided to transport the base material F fed from the feeding unit 10 to the image forming unit 30. Specifically, the transporting unit 20 has a first feed roller 21 and is configured to transport the fed base material F to the image forming unit 30 further on the downstream side in the feeding direction.

The image forming unit 30 is provided to sequentially discharge ink L (see FIG. 2) and an adhesive liquid onto the base material F fed from the transporting unit 20 and sequentially perform image formation (colored layer formation) and adhesive layer formation. Specifically, the image forming unit 30 includes a platen 34 as a medium support portion, and a carriage 31 that accommodates an ink jet head 32 having nozzle rows 33. Of these, the platen 34 is provided to support the base material F from the rear surface thereof. In addition, the carriage 31 opposes the platen 34, and is provided to move in a width direction X with respect to the feeding direction Y of the base material F by power of a carriage motor (not shown) while being guided by a first guide shaft (not shown).

The ink jet head 32 is provided in the carriage 31 and is provided to move integrally with the carriage 31 in the width direction X. In addition, the ink jet head 32 is configured to move relative to the carriage 31 in the feeding direction Y. Specifically, the ink jet head 32 is provided to move in the feeding direction Y by power of an ink jet head motor (not shown) while being guided by a second guide shaft (not shown). That is, the ink jet head 32 is configured to move in the feeding direction Y and the width direction X in a range opposing the platen 34. In addition, by sequentially discharging the ink L and the adhesive liquid from the nozzle rows 33 provided in a surface of the ink jet head 32 opposing the platen 34, image formation and adhesive layer formation on the base material F can be performed.

In addition, the nozzle rows 33 of the ink jet head 32 will be described later in detail.

In the platen 34, the first drying unit 40 is provided which evaporates at least a part of liquid components in the ink L and the adhesive liquid discharged toward the base material F.

The first drying unit 40 is provided in the platen 34 as shown in FIG. 2. Specifically, the first drying unit 40 has a first nichrome wire 42 as an example of a thermal conduction type heating unit 41. The first nichrome wire 42 is arranged in the inner part of the entire region of the platen 34 so as to be at a constant distance from the upper surface of the platen 34.

In addition, more on the downstream side in the feeding direction than the platen 34, as shown in FIG. 1, a second feed roller 43 is provided. The second feed roller 43 is configured to feed the base material F having an image forming thereon to the second drying unit 50 on the downstream side in the feeding direction. In addition, the second feed roller 43 is configured to cause the base material F to enter the second drying unit 50 from an inlet 63.

The second drying unit 50 is configured to further evaporate at least a part of remaining components in the liquid of ink L and the adhesive liquid discharged onto the base material F. In addition, in the vicinity of an outlet 64 of the second drying unit 50, a third feed roller 65 is provided. The third feed roller 65 is disposed to come into contact with the rear surface of the base material F and is configured to feed the base material F to the discharge unit 70 on the downstream side in the feeding direction.

The discharge unit 70 is provided to feed the base material F fed from the second drying unit 50 further on the downstream side in the feeding direction. Specifically, the discharge unit 70 has a fourth feed roller 71, a fifth feed roller 72, a sixth feed roller 73, a seventh feed roller 74, and a winding roller 75. Of these, the fourth feed roller 71 and the fifth feed roller 72 are disposed to come into contact with the surface of the base material F. In addition, the sixth feed roller 73 and the seventh feed roller 74 are disposed to form a roller pair. In addition, the base material F fed via the fourth, fifth, sixth, and seventh feed rollers 71, 72, 73, and 74 in this order is provided to be wound by the winding roller 75.

As a specific example of the transfer medium production apparatus 1a, although not particularly limited, for example, PX-7550 (ink jet printer, trade name produced by Seiko Epson Corporation) may be employed.

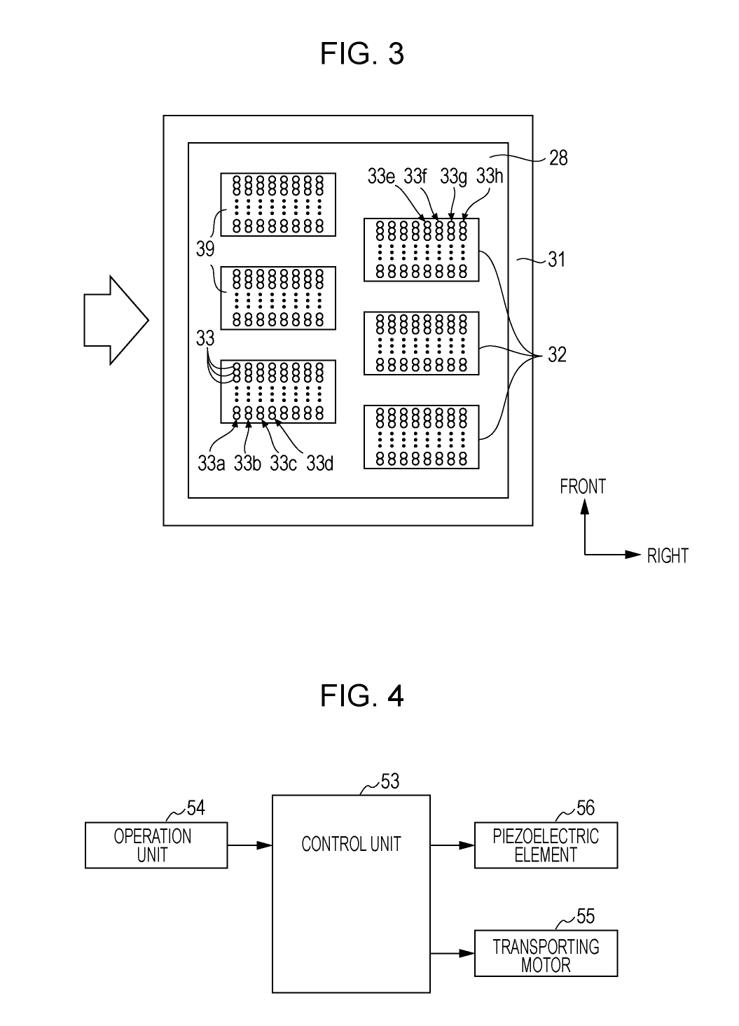

Subsequently, the nozzle rows 33 of the ink jet head 32 will be described in detail. FIG. 3 is a schematic diagram showing a nozzle formation surface 39 of the ink jet head 32, and FIG. 4 is a block diagram of a control configuration of the transfer medium production apparatus 1a.

As shown in FIG. 3, in a support plate 28 supported on the lower surface side of the carriage 31, a plurality of (in this embodiment, 6) ink jet heads 32 are supported to be arranged in a zigzag pattern (so that rows of the ink jet heads 32 adjacent in the feeding direction become significant) along the width direction (front and rear direction) perpendicular to the feeding direction (the direction shown by the outline arrow in FIG. 3) of the base material F. In addition, in the nozzle formation surface 39 which becomes the lower surface of each ink jet head 32, a plurality of rows (in this embodiment, 8 rows), that is, first to eighth nozzle rows 33a to 33h are regularly formed at predetermined intervals in the left and right direction along the front and rear direction by a number of the nozzle rows 33. In addition, a plurality of kinds of liquid are respectively supplied to the first to eighth nozzle rows 33a to 33h configured as described above from the cartridges (not shown) corresponding to the respective nozzle rows, and are discharged from the nozzle rows 33 in response to vibration of the piezoelectric elements 56 (see FIG. 4) provided to correspond to the respective nozzle rows 33.

That is, as an example, inks L containing cyan, magenta, yellow, black, and white colorants are sequentially supplied to the first to fifth nozzle rows 33a to 33e in the order from the first nozzle row 33a positioned on the most upstream side (left) in the feeding direction of the base material F. Moreover, a metallic ink as the ink L is supplied to the sixth nozzle row 33f positioned sixth from the left. In addition, as the ink L discharged from the first to sixth nozzle rows 33a to 33f is adhered to the base material F, a colored layer 81 as a pattern (see FIGS. 6A to 6D) is formed. In addition, the metallic ink is ink in which a metallic pigment as a colorant is dispersed in liquid and is ink that can form the metallic colored layer 81 by being adhered to the base material F.

In addition, the adhesive liquid is supplied to the seventh nozzle row 33g positioned seventh from the left. In addition, transparent protective liquid is supplied to the eighth nozzle row 33h positioned on the most downstream side (right) in the feeding direction of the base material F.

Subsequently, control of the transfer medium production apparatus 1a will be described.

In the transfer medium production apparatus 1a, a control unit 53 (see FIG. 4) configured from a microcomputer or the like which controls the overall driving of the transfer medium production apparatus 1a is provided. The control unit 53 controls driving of a piezoelectric element 56 and a transporting motor 55 on the basis of an input from an operation unit 54 operated by a user.

### 2. Production Method

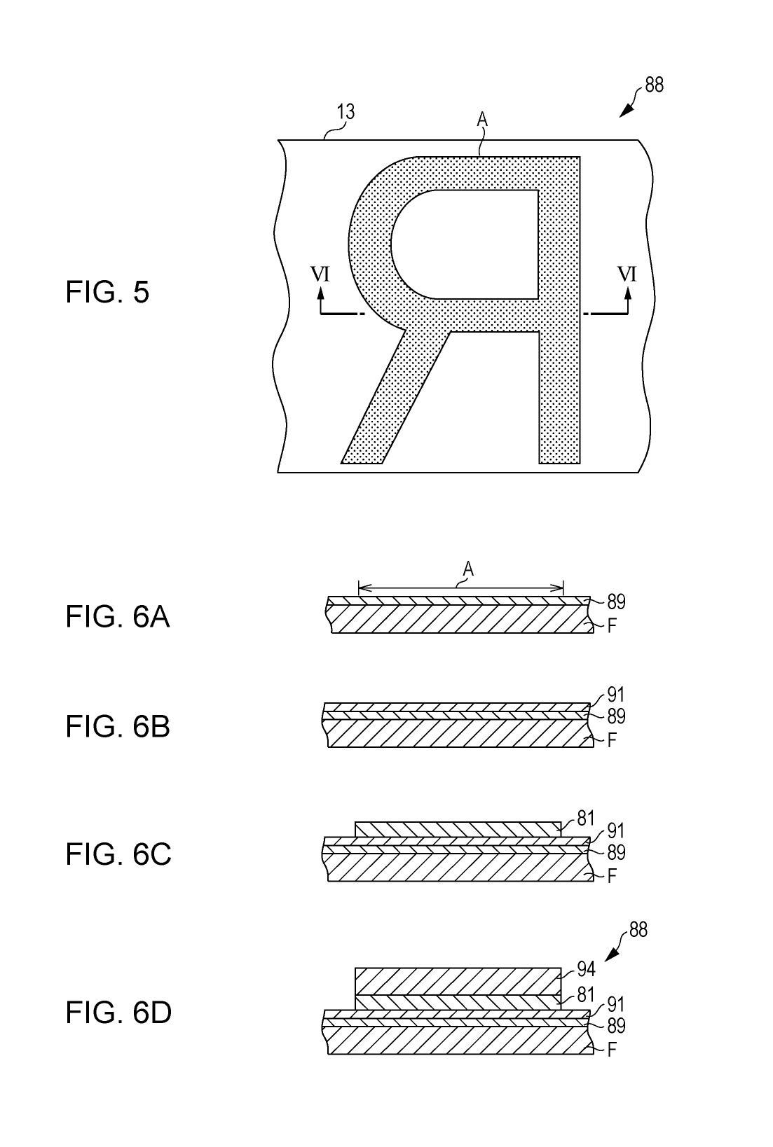

Subsequently, a production method used in a case where a transfer medium 88 is produced using the transfer medium production apparatus 1a will be described on the basis of FIGS. 5 and 6A to 6D. FIG. 5 is a schematic plan view of a transfer medium. FIGS. 6A to 6D show cross-sections taken along the line VI-VI in FIG. 5 that is the schematic plan view of the transfer medium and are cross-sectional views of production processes of the transfer medium.

The production method of a transfer medium using the transfer medium production apparatus 1a for aqueous pigment ink or non-aqueous pigment ink at least includes a colored layer forming process and an adhesive layer forming process.

In addition, as shown in FIG. 6A, on the surface of the side of a base material F (corresponding to the base material F of FIG. 1) where an image is formed in this embodiment, a release layer 89 is formed. The base material F is set in a transport path in a state where the downstream side end thereof in the feeding direction at a production start time point of the transfer medium 88 is wound around the center shaft (winding shaft) of the winding roller 75.

As shown in FIGS. 5 and 6A, when image forming data such as the letter R is input as image forming data for forming an image pattern using a colored layer, first, the control unit 53 sets a transfer region A to which the ink L is to be adhered. In addition, the transfer medium 88 produced in this embodiment transfers a transfer image formed on the transfer medium 88 to reverse left and right onto a medium to be transferred (not shown). Therefore, the control unit 53 sets the transfer region A in which the image corresponding to the image forming data is reversed left and right onto the transfer medium 88.

When production of the transfer medium 88 is started as the operation unit 54 is operated by the user, the control unit 53 causes the protective liquid, the ink L, and the adhesive liquid to be adhered onto the base material F by vibrating the piezoelectric elements 56. Hereinafter, each production process of the transfer medium will be specifically described.

### Preprocess in “FIG. 6B”

As desired, as a colored layer forming preprocess, the control unit 53 causes the piezoelectric element 56 to vibrate corresponding to the eighth nozzle row 33h according to the movement of the carriage 31 to cause the protective liquid to be adhered at least to the transfer region A. Accordingly, as shown in FIG. 6B, a protective layer 91 is formed on the base material F.

Here, since the first nichrome wire 42 of the thermal conduction type heating unit 41 in the first drying unit 40 generates heat as described later, the protective liquid (protective layer 91) adhered to the base material F is heated via the base material F. As a result, a component excluding solid contents from the protective layer 91, that is, a liquid component evaporates to a certain degree and thus the protective layer 91 is dried to a certain degree. However, a part of the liquid component remains on the protective layer 91.

### Colored Layer Forming Process in “FIG. 6C”

In the colored layer forming process which is necessary for the production method of this embodiment, the ink L is discharged from the ink jet head 32 toward the base material F and the ink L is adhered to a predetermined part on the base material F. Accordingly, as shown in FIG. 6C, a pattern of the colored layer 81 is formed on the base material F. In this process, the mass of liquid droplets during ink discharge may be adjusted in a range of, for example, 5 to 15 ng.

In the colored layer forming process, the control unit 53 (see FIG. 4) causes the piezoelectric elements 56 to vibrate corresponding to the first to sixth nozzle rows 33a to 33f according to the movement of the carriage 31. In addition, as shown in FIG. 6C, the ink L is discharged to be adhered to the transfer region A where the protective layer 91, thereby forming the colored layer 81. For example, in a case where a transfer medium 88 for foil transfer is produced, the colored layer 81 is formed using metallic ink. Specifically, metallic ink is first adhered to the transfer region A and white ink is thereafter adhered to the transfer area A, thereby forming a silver colored layer 81.

The colored layer forming process will be more specifically described with reference to FIG. 2. First, the base material F fed onto the platen 34 of the image forming unit 30 is temporarily stopped. In addition, in a state where the ink jet head 32 is present at a position opposing the downstream side in the feeding direction Y on the platen 34, the carriage 31 is moved in the width direction X, and the ink L is discharged and image formation is performed. Next, the ink jet head 32 is moved by the length of the nozzle row 33 on the upstream side in the feeding direction Y with respect to the carriage 31. In addition, the carriage 31 is moved in the width direction X, and the ink L is discharged and image formation is performed. Moreover, the ink jet head 32 is further moved by the length of the nozzle row 33 on the upstream side in the feeding direction Y with respect to the carriage 31. In addition, the carriage 31 is moved in the width direction X and the ink L is discharged. When image formation is not completed, the ink jet head 32 is moved to a position opposing the upstream side in the feeding direction Y of the platen 34, and the carriage 31 is moved in the width direction X in this state and the ink L is discharged again. The series of operations are repeated. On the other hand, when image formation is completed, the operations are ended. By ending the operations, formation of the colored layer 81 (see FIG. 6C) is completed.

In addition, the colored layer forming process in this embodiment is only an example of the aspect described above, and does not limit this embodiment. As a modified aspect, in a case where the ink jet head 32 is moved to the upstream side in the feeding direction Y, the ink jet head 32 may be moved by a distance shorter than the length of the nozzle row 33. Accordingly, it becomes possible to increase the density of the image resolution.

### First Drying Process

As desired, a first drying process of evaporating at least a part of the liquid component contained in the ink L of the colored layer 81 is further performed. In a case where an aqueous pigment ink is used as the ink L, the amount of the liquid component evaporated from the ink L discharged and adhered to the base material F is preferably 65 to 95 mass % with respect to the total mass (100 mass %) of the corresponding liquid component, and more preferably, is 70 to 90 mass %. On the other hand, in a case where a non-aqueous pigment ink is used as the ink L, the amount of the liquid component evaporated from the ink L discharged and adhered to the base material F is preferably 50 to 90 mass % with respect to the total mass (100 mass %) of the corresponding liquid component, and more preferably, is 55 to 85 mass %. As such, after a certain amount of the liquid component is evaporated from the ink L discharged and adhered onto the base material F, the adhesive liquid is adhered in a subsequent process. Therefore, the pattern of the colored layer 81 in the transfer medium can be formed with high precision and transferability is excellent.

The first drying process can be performed by, as well as the thermal conduction type heating unit 41 (platen heater) provided in the platen 34, a warm air heater, an infrared heater, or the like. As an example of an evaporation unit in the case where the platen heater is used, heating the base material F from the rear surface using the platen heater and causing warm air to come into contact with the ink L adhered to the base material F may be employed. By employing the evaporation unit, heat is substantially uniformly transferred to the ink L on the base material F, so that the evaporation amount can be easily adhered and curling can be prevented in a case where the base material F is paper or the like. Specifically, the evaporation amount can be adjusted by controlling heating temperature, heating time, warm air temperature, air volume, and the like of the heater of platen 34. It is preferable that the heater set conditions by measuring the evaporation amount in advance of starting production.

In addition, the evaporation amount can be derived by measuring a change in the mass of the ink before and after evaporating the liquid component in the same condition as the main process. Therefore, after a condition in which a desired amount of the liquid component is evaporated is obtained in advance, an evaporation process of the main process may be performed under the same condition.

In the first drying process, the control unit 53 (see FIG. 4) causes the first nichrome wire 42 of the thermal conduction type heating unit 41 under a condition set in advance so that the at least a part of the liquid component in the colored layer 81 is evaporated and the colored layer 81 is dried to a desired degree. Accordingly, the ink L (the colored layer 81) discharged and adhered to the base material F is heated via the protective layer 91 according to the base material F and the region, and a predetermined amount of the liquid component in the corresponding ink L is evaporated and thus the colored layer 81 is dried. The first drying process may be performed simultaneously with the colored layer forming process and may be performed after the colored layer forming process (preferably, before the adhesive layer forming process).

Here, the thermal conduction type heating unit 41 has preferably a thermal conduction type other than a convection type. By employing the thermal conduction type, there is no concern of the first to eighth nozzle rows 33a to 33h of the ink jet head 32 being directly sprayed with warm air, so that there is no concern of the state of the nozzle rows 33a to 33h being affected. Specifically, there is no concern of discharge defects due to an increase in the viscosity caused by ink in the nozzles being dried. In addition, a degree of heating by the thermal conduction type heating unit 41 may be reduced to a degree of heating of a drying furnace 52 described later. The degree may be a degree that does not affect the state of the first to eighth nozzle rows 33a to 33h of the ink jet head 32.

### Adhesive Layer Forming Process in “FIG. 6D”

In the adhesive layer forming process that is necessary for the production method of this embodiment, in a state where at least a part of the liquid component in the ink L adhered to the base material F is evaporated, the adhesive liquid is discharged from the ink jet head 32 to be adhered to a predetermined part on the surface to which the ink L is adhered. Accordingly, as shown in FIG. 6D, the pattern of the adhesive layer 94 is formed on the colored layer 81 (and a part of the base material F depending on the case). The mass of liquid droplets during adhesive liquid discharge in the main process may be adjusted to a range of, for example, 5 to 15 ng.

In the adhesive layer forming process, the control unit 53 (see FIG. 4) causes the piezoelectric element 56 to vibrate corresponding to the seventh nozzle row 33g according to the movement of the carriage 31 and as shown in FIG. 6D, causes the adhesive liquid to be discharged and adhered to the transfer area A, thereby forming an adhesive layer 94 that is thinner than the colored layer 81.

The adhesive layer forming process will be more specifically described with reference to FIG. 2. First, as the base material F having the image formed, the carriage 31, and the ink jet head 32 are operated in the same manner with the colored layer forming process, the adhesive liquid is discharged from the ink jet head 32 toward the colored layer 81 (see FIG. 6D) such that the adhesive layer 94 (see FIG. 6D) is formed on the corresponding colored layer. Thereafter, the base material F is fed to the downstream side in the feeding direction Y by the length of the platen 34 along the feeding direction Y, that is, by the length of the area along the feeding direction Y, where the image is formed by a plurality of scanning operations, and is temporarily stopped again. In addition, image formation and adhesive layer formation are performed on the base material F on the platen 34 by a plurality of scanning operations. That is, image formation and adhesive layer formation are performed by so-called intermittent feeding.

During layer formation as described above, that is, before pressure bonding, the thickness of the adhesive layer 94 may be formed to be smaller than the thickness of the colored layer 81. The reason is that transferability is excellent. On the other hand, after pressure bonding, the relationship becomes more significant. The reason is that, since the colored layer 81 is relatively hard, a degree of pressure bonding becomes smaller, but since the adhesive layer 94 is relatively soft, a degree of pressure bonding becomes greater.

The thicknesses of the colored layer 81 and the adhesive layer 94 can be adjusted according to the masses of the ink L and the adhesive liquid adhered to the unit area of the base material F. Therefore, it is preferable that conditions be set by measuring the thickness of only the colored layer or only the adhesive layer before starting production.

Here, the thickness of the layer can be calculated from a photograph enlarged by about 1 to 100,000 times by a cross-sectional observation method called microtome-transmission electron microscopy. A transmission electron microscope (TEM) illuminates a specimen with an electron beam emitted from an electron gun in a vacuum and enlarging the transmission image using a magnetic field lens, thereby obtaining an enlarged image of a material. Microtome is a specimen preparing method of preparing a piece with a thickness that can transmit an electron beam.

Here, in FIG. 6D, the colored layer 81 and the adhesive layer 94 are shown to be separated from each other. However, practically, the colored layer 81 and the adhesive layer 94 are not (clearly) separated from each other. This is because there may be a case where the adhesive liquid is discharged in a state where not all liquid components contained in the colored layer 81 are evaporated and in this case, the adhesive layer may be mixed with the colored layer 81. In addition, when the adhesive layer 94 is provided in a state where the colored layer 81 is not completely dried, it is expected that the fixing strength is increased due to a so-called anchor effect.

In the case where the colored layer 81 and the adhesive layer 94 are not (clearly) separated from each other, the thickness of each layer is specified by the thicknesses of the colored layer 81 and the adhesive layer 94 based on the condition settings.

### Second Drying Process

As desired, a second drying process is further performed. The second drying process is for forcibly evaporating the liquid components contained in the colored layer 81 and the adhesive layer 94 on the base material F.

As an evaporation unit in the second drying process, as well as heating such as the drying furnace 52 (see FIG. 1) that is an example of a convection type heating unit 51 in the second drying unit 50, pressure reduction and contacting dry air or warm air may be employed. In the case where an aqueous pigment ink is used as the ink L, in the second drying process, it is preferable that more than 95 mass % of the liquid components contained in the ink L and the adhesive liquid adhered to the base material F be evaporated. On the other hand, in the case where a non-aqueous pigment ink is used as the ink L, in the second drying process, it is preferable that more than 90 mass % of the liquid components contained in the ink L and the adhesive liquid adhered to the base material F be evaporated.

In the second drying process, when image formation (printing) performed on the base material F as described above is completed, the control unit 53 (see FIG. 4) drives the transporting motor 55 to transport the base material F to the downstream side in the feeding direction so as to be subjected to an evaporation and drying process in the drying furnace 52 which is an example of the convection type heating unit 51 in the second drying unit 50. Accordingly, the liquid components contained in the colored layer 81 and the adhesive layer 94 are evaporated, and the dried protective layer 91, the colored layer 81, and the adhesive layer 94 are finally fixed onto the base material F. Thereafter, the base material F is wound around the center shaft (winding shaft) of the winding roller 75 so that the adhesive layer 94 comes into contact with the rear surface of the base material F.

In addition, the second drying process may be performed simultaneously with the adhesive layer forming process or may be performed after the adhesive layer forming process. In addition, the drying furnace 52 is not particularly limited in terms of structure and a well-known drying furnace may be used.

Otherwise, without performing the second drying process, after the adhesive layer forming process, the liquid components contained in the colored layer and the adhesive layer may be evaporated by natural drying.

In addition, in a case where the adhesive liquid is one obtained by dispersing microcapsules (those containing an adhesive component including a thermoplastic resin) in a liquid, the temperature of the drying furnace 52 is set to a temperature so as not to break down the microcapsules in the adhesive layer 94. Accordingly, adhesion between the rear surface of the base material F and the adhesive layer 94 can be weakened compared to adhesion between the protective layer 91 and the colored layer 81 and between the colored layer 81 and the adhesive layer 94. Therefore, in a case where the wound base material F is unwound, the rear surface of the base material F is separated from the adhesive layer 94, and the protective layer 91, the colored layer 81, and the adhesive layer 94 are in a state of being formed on the surface of the base material F in a laminated form in the order from the base material F side.

In addition, the adhesion between the protective layer 91 and the colored layer 81 and between the colored layer 81 and the adhesive layer 94 is stronger than the adhesion between the protective layer 91 and the release layer 89. Therefore, in the case where the colored layer 81 is transferred onto the medium to be transferred, first, an additional process is performed on the adhesive layer 94 to break down the microcapsules. In addition, by adhering the adhesive layer 94 that exhibits adhesiveness to the medium to be transferred and separating the base material F, the release layer 89 and the protective layer 91 are separated from each other, and thus the colored layer 81 is transferred onto the medium to be transferred while the surface thereof is protected by the protective layer 91.

When the transfer medium production apparatus 1a is used, the following effects can be obtained.

That is, in a state where the ink L is adhered to the base material F and at least a part (preferably 65 to 95 mass % in the case where the ink L is an aqueous pigment ink, and preferably 50 to 90 mass % in the case where the ink L is a non-aqueous pigment ink) of the liquid components is evaporated, as the adhesive liquid is adhered onto the colored layer 81, the adhesive liquid is adhered in a state where the ink L looses liquidity to some extent. Therefore, the adhesive liquid can be adhered without collapse of the pattern by the colored layer 81, thereby obtaining the pattern of the colored layer with high precision. In addition, the adhesive liquid can be adhered in a state where part of the liquid components remains in the colored layer 81. In this case, the adhesion between the colored layer 81 and the adhesive layer 94 becomes stronger than the adhesion between the protective layer 91 and the release layer 89, such that the transfer medium 88 capable of properly performing transfer on the medium to be transferred can be produced. Moreover, the ink L is adhered in the state where a part of the liquid components remains in the protective layer 91, and the adhesive layer can be adhered in the state where a part of the liquid components remains in the colored layer 81. In this case, the adhesion between the protective layer 91 and the colored layer 81 and between the colored layer 81 and the adhesive layer 94 becomes stronger than the adhesion between the protective layer 91 and the release layer 89. Therefore, the transfer medium 88 capable of properly transferring the protective layer 91 also onto the medium to be transferred can be produced.

In addition, as the ink L is adhered to the transfer region A to which the protective liquid is adhered, the surface of the colored layer 81 is protected by the protective layer 91, such that durability of the colored layer 81 transferred onto the medium to be transferred can be enhanced. Moreover, in the state where a part of the liquid components remains in the protective layer 91, by adhering the ink L, for example, the adhesion can be strengthened compared to the adhesion between the colored layer 81 and the protective layer 91 in a case where the liquid components does not substantially remain in the protective layer 91.

Moreover, by forming the protective layer 91 between the base material F and the colored layer 81, the colored layer 81 can be formed regardless of compatibility between the base material F and the ink L. That is, for example, even in a case where image formation (printing) is performed on the base material F made of a resin having water repellency using a liquid (ink) colored by a pigment, by forming the protective layer 91 using a transparent coating agent containing inorganic particles such as silica or a swellable resin, fixability of the ink L onto the base material F can be enhanced.

In addition, in the case where the adhesive liquid is one obtained by dispersing the microcapsules described layer in a liquid, by discharging the adhesive liquid by vibrating the piezoelectric element 56, the adhesive liquid can be adhered to the base material F in a state where the microcapsules are not broken down but are maintained. That is, the adhesive liquid can be discharged in the state where adhesion of the adhesive liquid is maintained at a low level, so that clogging of ink jet nozzles can be suppressed.

In addition, the embodiment can be modified as follows. First, instead of or in addition to the thermal conduction type heating unit 41 embedded in the platen 34, a radiation type heater that radiates electromagnetic waves onto the platen 34 so as to be heated, or an evaporation and drying device such as a blowing device that blows wind (warm air) may be provided. In addition, heads that discharge the ink L, the protective liquid, and the adhesive liquid may be individually provided. Moreover, the protective liquid may not be adhered and the protective layer 91 may not be formed. In this case, the release layer 89 also has the function as the protective layer.

In addition, a film in which the protective layer 91 is formed may also be used. Moreover, a mechanism that discharges a release agent to the ink jet head 32 may further be provided to form the release layer 89 by discharging the release agent to the base material F. In this case, the release agent is discharged to the transfer region A and the release layer 89 may be formed according to the shape of the colored layer 81.

In addition, the production method of this embodiment may have, before the colored layer forming process, a process of forming the protective layer 91 on the base material F surface (on the release layer 89 in the case where the base material F has the release layer 89) on a side where the colored layer 81 of the base material F is to be formed. Formation of the protective layer 91 is performed by, for example, adhering the protective liquid to the base material F surface (the release layer 89) and drying the protective liquid as needed. By forming the protective layer 91, the surface of the colored layer 81 after transfer is protected by the protective layer 91, and the durability of the colored layer 81 adhered to the medium to be adhered can be enhanced. Examples of the protective liquid include liquids containing an acrylic acid ester resin, a methacrylic acid ester resin, a copolymer resin of acrylic acid ester and methacrylic acid ester, a copolymer resin of acrylic acid ester and styrene, a copolymer resin of acrylic acid ester, methacrylic acid ester, and styrene, a polyvinyl alcohol resin, and the like. If the thickness of the protective layer 91 is lower than 10 nm, the colored layer 81 cannot be sufficiently protected. On the other hand, if the thickness thereof is higher than 30 nm, it is not preferable in terms of production costs of the protective layer 91. Otherwise, the thickness is increased in a case of the base material F having a roll form. Therefore, the thickness is preferably 10 to 30 nm.

### Transfer Medium Production Apparatus for UV-Curable Pigment Ink

A second aspect of this embodiment relates to a production method using a transfer medium production apparatus suitable for a case where a UV-curable pigment ink is used as the ink L. In addition, since the second aspect is a modified example of the first aspect, the following description will be provided on the basis of different parts from those of the first aspect.

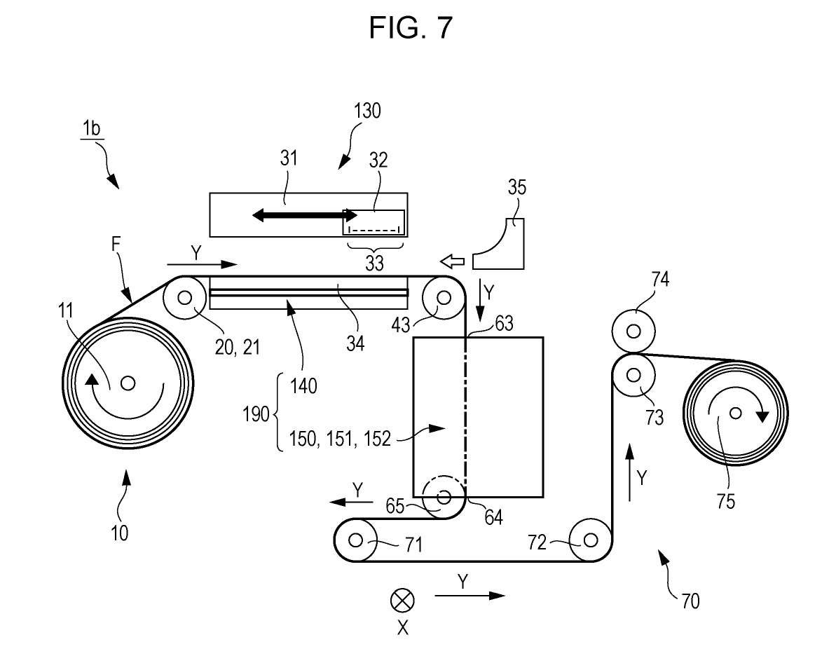

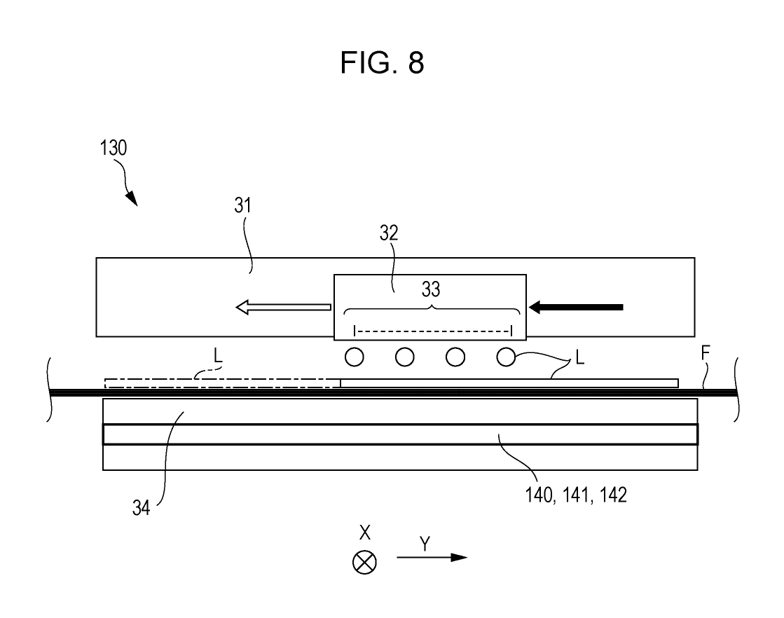

FIG. 7 is a side view schematically showing the entirety of a transfer medium production apparatus 1b used in the second aspect of this embodiment. FIG. 8 is a side view schematically showing an image forming unit 130 of the transfer medium production apparatus 1b.

As shown in FIG. 7, the transfer medium production apparatus 1b includes a feeding unit 10 of a base material, a transporting unit 20, the image forming unit 130, a fixing unit 190, and a discharge unit 70.

Of these, in the second aspect, the configurations of the image forming unit 130 and the fixing unit 190 are mainly different from those of the first aspect. The fixing unit 190 has a first fixing unit 140 and a second fixing unit 150.

Since the first fixing unit 140 exhibits the same function as the first drying unit 40 in the first aspect, description thereof will be omitted herein. In addition, the thermal conduction type heating unit 141 and the first nichrome wire 142 also have the same functions as those of the thermal conduction type heating unit 41 and the first nichrome wire 42, respectively. Since the image forming unit 130 shown in FIG. 8 has the same configuration as the image forming unit in the first aspect, description thereof will be omitted herein.

The second fixing unit 150 causes remaining components in the ink L adhered to the base material F to polymerize and be cured, and thus is configured to emit UV rays or electron beams.

The second fixing unit 150 has a UV illumination device 152 that is an example of a UV illumination unit 151. In the UV illumination device 152, a first UV lamp, a second UV lamp, and a third UV lamp (all not shown) are provided. In a case where the UV illumination device 152 uses light-emitting diodes (LED) as a UV illumination source, it is preferable that an LED having an emission peak wavelength of 395 nm be used as the first UV lamp, an LED having an emission peak wavelength of 380 nm be used as the second UV lamp, and an LED having an emission peak wavelength of 365 nm be used as the third UV lamp. In addition, the UV illumination device 152 is not particularly limited in terms of structure and a well-known UV illumination device may be used.

The first fixing unit 140 may be equipped with a warm air fan 35 as a convection type heating unit. By causing warm air to come into contact with the base material F surface on the platen 34, the liquid components in the ink L adhered to the base material F can be efficiently evaporated. The warm air fan 35 may be replaced with a UV lamp as needed or both may also be installed.

In the second aspect, the colored layer 81 is formed by performing drying in the first fixing unit 140 and curing in the second fixing unit 150. Thereafter, the base material F is transported to the first fixing unit 140 and the adhesive liquid is adhered onto the colored layer 81 as in the first aspect. Moreover, by drying the liquid components contained in the adhesive liquid using the platen 34 and the warm air fan 35, the adhesive layer 94 is formed.

In addition, as a modified example of the second aspect, a first heating unit and a UV illumination unit may be provided in the first fixing unit, and a second heating unit may be provided in the second fixing unit.

As a specific example of an ink jet recording apparatus used in the transfer medium production apparatus 1b, although not particularly limited, PX-5600 (ink jet printer, trade name produced by Seiko Epson Corporation) may be employed.

In addition, a production method in a case where the transfer medium 88 is produced using the transfer medium production apparatus 1b will be supplemented. A UV-curable pigment ink is used as the ink L in the first drying process in the production method. Here, the amount of the liquid component evaporated from the ink L discharged and adhered to the base material F is preferably 40 to 70 mass % with respect to the total mass (100 mass %) of the liquid component and is more preferably 35 to 65 mass %. In this case, as described above, the pattern of the colored layer 81 in the transfer medium can be formed with high precision, and transferability is excellent.

Hereinafter, as the configuration other than the production apparatus, details of appropriate base materials and various kinds of ink for embodying the production method that have been described until now will be described.

### Base Material

As the base material, although not particularly limited, metal, wood, plastic, or paper can be employed. Of these, metal, plastic, or paper is preferable since the base material F can be easily processed into a predetermined shape, and additionally in terms of costs, plastic is more preferable.

As the metal, in terms of costs, aluminum is preferably employed. As the plastic, a polyolefin resin, a polyester resin, a polyamide resin, a polycarbonate resin, and the like are preferably employed. As the paper, plain paper, high-quality paper, coated paper, and the like are preferably employed.

Moreover, as the base material F, an ink non-absorbent or low-absorbent base material may be appropriately used. As the ink non-absorbent base material F, for example, a plastic film in which a surface treatment for ink jet printing is not performed (that is, an ink absorption layer is not formed), one in which plastic is coated on or a plastic film is adhered to a base material F such as paper, and the like may be employed. As the plastic mentioned here, polyvinyl chloride, polyethylene terephthalate, polycarbonate, polystyrene, polyurethane, polyethylene, polypropylene, and the like may be employed. Examples of the ink low-absorbent base material F include art paper, coated paper, printing paper such as mat paper, and the like.

In addition, the ink non-absorbent and low-absorbent base material represents a base material of which a printing surface has a water absorbency of equal to or lower than 10 mL/m² from a contact start until 30 msec in the Bristow method. The Bristow method is the most popularized method as a measurement method of a liquid absorbency for a short time and is employed by the Japan Technical Association of the Pulp and Paper Industry (JAPAN TAPPI). Details of the test method are described in the standard No. 51 (paper and paper board-liquid absorbency test method—Bristow method) of “JAPAN TAPPI paper pulp test method 2000 edition”.

The base material F preferably has a sheet form or a film form in order to facilitate use of the transfer medium. It is preferable that the thickness of the base material F be 10 to 50 μm.

The base material F may be coated with a release agent on at least one of a side where the colored layer 81 is to be formed and the reverse side and may have the release layer 89 formed by the coated layer. As the base material F has the release layer 89 on the side where the colored layer 81 is to be formed, transfer from the transfer medium to the medium to be transferred is performed more easily. From this point of view, it is preferable that the release layer 89 be provided at least on the side of the base material F where the colored layer 81 is to be formed. In addition, as the base material F has the release layer 89 on the reverse side to the side where the colored layer 81 is to be formed, when transfer media are overlapped, the transfer media are suppressed from coming into contact with each other and being difficult to be separated from each other. Examples of the release agent include a polyethylene wax-based release agent, a silicone-based release agent, and a fluorine-based release agent. In addition, when the thickness of the release layer 89 is smaller than 10 nm, sufficient transferability is not obtained. On the other hand, when the thickness thereof is greater than 30 nm, it is not preferable in terms of production costs of the release layer 89, or when the base material F is shaped into a roll form, the base material F becomes bulky. Therefore, the thickness thereof is preferably 10 to 30 nm.

### Ink

The ink L is used to form the colored layer 81. The ink L contains a colorant and the colorant is a pigment for enhancing light resistance of the ink. In addition, it is preferable that the ink L be an aqueous pigment ink, a non-aqueous pigment ink, or a UV-curable pigment ink (any of the aqueous pigment ink, the non-aqueous pigment ink, and the UV-curable pigment ink).

### Aqueous Pigment Ink

When the aqueous pigment ink is used as the ink L, particularly discharge stability of the ink is excellent. It is preferable that the aqueous pigment ink contain at least the following components:

(1) pigment
(2) at least any of a pigment dispersant, a thermoplastic resin in an emulsion form (hereinafter, also called “resin emulsion”), and a water-soluble thermoplastic resin (hereinafter, also called “water-soluble resin”)
(3) a water-soluble organic solvent having an intermediate boiling point so that a boiling point at 1 atm is equal to or lower than 250° C. (more preferably, equal to or higher than 70° C. and equal to or lower than 250° C.)
(4) surfactant
(5) water.

The content of each of the components (1) to (5) with respect to the total mass (100 mass %) of the ink will be described. The content of the component (1) is preferably 0.2 to 10 mass %. The content of the component (2) is preferably 1.5 to 15 mass %. The content of the component (3) is preferably 5 to 40 mass %. The content of the component (4) is preferably 0.5 to 2 mass %. The content of the component (5) is preferably 50 to 92 mass %. When the content of each component is within the corresponding range, discharge stability is extremely excellent.

Details of each component will be described later, and the components may be used singly or in combinations of two or more kinds thereof.

### Non-Aqueous Pigment Ink

It is preferable that the non-aqueous pigment ink as the ink L contain at least the following components in order to enhance discharge stability:

(6) pigment
(7) a water-soluble organic solvent having an intermediate boiling point so that a boiling point at 1 atm is equal to or lower than 250° C. (more preferably, equal to or higher than 70° C. and equal to or lower than 250° C.)

Here, it is preferable that the non-aqueous pigment ink in this embodiment of the invention do not substantially contain water. Here, “do not substantially contain water” includes, as well as a case where water is not absolutely contained and a case where water is contained within a range that does not impede dispersion of a pigment. The content of water contained in the non-aqueous pigment ink in this embodiment is preferably equal to or lower than, for example, 0.5 mass %.

The content of each of the components (6) and (7) with respect to the total mass (100 mass %) of the ink will be described. The content of the component (6) is preferably 0.2 to 10 mass %. The content of the component (7) is preferably 70 to 99.8 mass %. When the content of each component is within the corresponding range, discharge stability is excellent.

In addition, the non-aqueous pigment ink has excellent adhesion by further containing the component (8) as follows:

(8) a thermoplastic resin.

Details of each component will be described later, and the components may be used singly or in combinations of two or more kinds thereof.

### UV-Curable Pigment Ink

It is preferable that the UV-curable pigment ink contain at least the following components in order to enhance discharge stability:

(9) pigment
(10) a monomer having a boiling point of equal to or higher than 100° C. and equal to or lower than 250° C.
(11) at least any of a polymerizable oligomer and a polymer
(12) a photopolymerization initiator.

The content of each of the components (9) to (12) with respect to the total mass (100 mass %) of the ink will be described. The content of the component (9) is preferably 0.2 to 10 mass %. The content of the component (10) is preferably 30 to 70 mass %. The content of the component (11) is preferably 10 to 50 mass %. The content of the component (12) is preferably 3 to 10 mass %. When the content of each component is within the corresponding range, discharge stability is excellent.

In addition, it is more preferable that the UV-curable pigment ink further contain the component (13) as follows:

(13) at least any of a water-soluble organic solvent having an intermediate boiling point so that a boiling point at 1 atm is equal to or lower than 250° C. (more preferably, equal to or higher than 70° C. and equal to or lower than 250° C.) and water.

Details of each component will be described later, and the components may be used singly or in combinations of two or more kinds thereof.

### Adhesive Liquid

The adhesive liquid is used for forming the adhesive layer 94, and preferably contains a thermoplastic resin in order to enhance transferability and adhesiveness with the medium to be transferred or the colored layer during transfer. As the adhesive liquid, an aqueous liquid (a liquid including water as a main component) containing a thermoplastic resin in an emulsion form may be employed. In order to efficiently distribute a thermoplastic resin that functions as an adhesive agent to the surface layer, an aqueous liquid containing a thermoplastic resin in an emulsion form is preferable.

The aqueous liquid containing the thermoplastic resin (resin emulsion) in the emulsion form preferably contains at least the following components (14) to (16) as constituent components in order to form the pattern of the colored layer 81 and the adhesive layer 94 in the transfer medium with high precision and enhance transferability:

(14) a resin emulsion
(15) a water-soluble organic solvent having an intermediate boiling point so that a boiling point at 1 atm is equal to or lower than 250° C. (more preferably, equal to or higher than 70° C. and equal to or lower than 250° C.)
(16) water.

Details of each component will be described later, and the components may be used singly or in combinations of two or more kinds thereof.

The content of each of the components with respect to the total mass (100 mass %) of the adhesive liquid will be described. The content of the component (14) is preferably 2.5 to 25 mass %. The content of the component (15) is preferably 10 to 40 mass %. The content of the component (16) is preferably 45 to 87.5 mass %. When the content of each component is within the corresponding range, discharge stability of the adhesive liquid is excellent.

Here, the adhesive liquid in this embodiment may be one obtained by dispersing microcapsules containing an adhesive component having a thermoplastic resin therein in a liquid. When the adhesive liquid is used, the adhesiveness can be enhanced by performing an additional process such as a heating process or a pressurizing process and breaking down the microcapsules.

In addition, “resin” mentioned therein is all kinds of resin contained in each of the ink and the adhesive liquid and is preferably a thermoplastic resin.

### Constituent Components of Ink and Adhesive Liquid

Hereinafter, the constituent components of the ink L and the adhesive liquid will be described in detail.

### Pigment

As the pigment contained in the ink, any of an inorganic pigment and an organic pigment may be used.

As the inorganic pigment, carbon black (C.I. pigment black 7) kinds such as furnace black, lamp black, acetylene black, and channel black, iron oxide, and titanium oxide may be used.

As a specific example of the carbon black, although not particularly limited, No. 2300, No. 900, MCF88, No. 20B, No. 33, No. 40, No. 45, No. 52, MA7, MA8, MA100, No. 2200B, and the like (hereinbefore, trade names all produced by Mitsubishi Chemical Corporation); Color Black FW1, FW2, FW2V, FW18, FW200, 5150, 5160, 5170, Printex 35, U, V, 140U, Special Black 6, 5, 4A, 4, 250, and the like (hereinbefore, trade names all produced by Degussa AG); Conductex SC, Raven 1255, 5750, 5250, 5000, 3500, 1255, 700, and the like (hereinbefore, trade names all produced by Columbian Carbon Co., Ltd.); and Regal 400R, 330R, 660R, Mogul L, Monarch 700, 800, 880, 900, 1000, 1100, 1300, 1400, Elftex 12, and the like (hereinbefore, trade names all manufactured by Cabot Corporation) may be employed.

Such carbon black kinds may be used singly or in combinations of two or more kinds thereof.

In addition, as a pigment contained in an achromatic white ink (white ink), one or more kinds selected from the group consisting of titanium oxide such as chlorination method titanium oxide (rutile type) CR-50 (trade name produced by ISHIHARA SANGYO KAISHA, LTD.), barium sulfate, and a hollow white resin emulsion are preferable.

In addition, examples of an organic pigment for a chromatic color ink from among organic pigments include, although not particularly limited, a quinacridone-based pigment, a quinacridone quinone-based pigment, a dioxazine-based pigment, a phthalocyanine-based pigment, an anthrapyrimidine-based pigment, an anthanthrone-based pigment, an indanthrone-based pigment, a flavanthrone-based pigment, a perylene-based pigment, a diketopyrrolopyrrole-based pigment, a perinone-based pigment, a quinophthalone-based pigment, an anthraquinone-based pigment, a thioindigo-based pigment, a benzimidazolone-based pigment, an isoindolinone-based pigment, an azomethine-based pigment, and an azo-based pigment.

Specific examples of a cyan pigment used for the cyan ink include, although not particularly limited, C.I. Pigment Blue 1, 2, 3, 15:3, 15:4, 15:34, 16, 22, 60, and the like, and C.I. Vat Blue 4, 60, and the like. Of these, one or more kinds selected from the group consisting of C.I. Pigment Blue 15:3, 15:4, and 60 are preferably employed.

Specific examples of a magenta pigment used for the magenta ink include, although not particularly limited, C.I. Pigment Red 5, 7, 12, 48(Ca), 48(Mn), 57(Ca), 57:1, 112, 122, 123, 168, 184, and 202 and C.I. Pigment Violet 19. Of these, one or more kinds selected from the group consisting of C.I. Pigment Red 122, 202, and 209 and C.I. Pigment Violet 19 are preferably employed.

Specific examples of a yellow pigment used for the yellow ink include, although not particularly limited, C.I. Pigment Yellow 1, 2, 3, 12, 13, 14C, 16, 17, 73, 74, 75, 83, 93, 95, 97, 98, 109, 110, 114, 128, 129, 138, 150, 151, 154, 155, 180, and 185. Of these, one or more kinds selected from the group consisting of C.I. Pigment Yellow 74, 109, 110, 128, and 138 are preferably employed.

Specific examples of a pigment used for an orange pigment dispersion liquid used for the orange ink include, although not particularly limited, C.I. Pigment Orange 36 or 43 and a mixture thereof.

Specific examples of a pigment used for a green pigment dispersion liquid used for the green ink include, although not particularly limited, C.I. Pigment Green 7 or 36 and a mixture thereof.

A metallic pigment used for the metallic ink is, although not particularly limited as long as it has a function such as metallic gloss, preferably aluminum or an aluminum alloy, or silver or a silver alloy. Of these, in order to reduce costs and enhance the metallic gloss, aluminum or the aluminum alloy is preferable. In a case where the aluminum alloy is used, as other metallic elements or non-metallic elements that can be added to aluminum, although not particularly limited as long as it has a function of having metallic gloss or the like, silver, gold, platinum, nickel, chrome, tin, zinc, indium, titanium, and copper may be employed. In addition, at least one kind of the single elements, the alloys, and the mixtures thereof may be appropriately used.

Such pigments may be used by being subjected to resin dispersion using well-known dispersible resins, or may be used as self-dispersible pigments by oxidizing or sulfonating the pigment surfaces using ozone, hypochlorous acid, fuming sulfuric acid, or the like.

### Dispersant

It is preferable that the ink contain a dispersant in terms of increasing pigment dispersibility. Examples of the dispersant include, although not particularly limited, a dispersant that is commonly used for preparing a pigment dispersion liquid such as a polymer dispersant. As a specific example, a dispersant mainly containing one or more kinds of polyoxyalkylene polyalkylene polyamine, a vinyl polymer and a copolymer thereof, an acrylic polymer and a copolymer thereof, polyester, polyamide, polyimide, polyurethane, an amino-based polymer, a silicon-containing polymer, a sulfur-containing polymer, a fluorine-containing polymer, and an epoxy resin may be employed. As commercially available items of the polymer dispersant, there are Discole Series (N-509 and the like) produced by Dainichiseika Color & Chemicals Mfg. Co., Ltd., AJISPER series produced by Ajinomoto Fine-Techno Co., Inc., SOLSPERSE series produced by Avecia, Disperbyk produced by BYK-Chemie Japan K.K., DISPARLON series produced by Kusumoto Chemicals, Ltd., and the like. In addition, it is preferable to control hydrophilicity of the dispersant according to the kind of ink (aqueous pigment ink or non-aqueous pigment ink), and it is preferable that control of hydrophilicity be performed by hydrophilic groups (for example, hydroxyl groups, carboxyl groups, and sulfo groups).

### Thermoplastic Resin

In terms of increasing transferability and adhesiveness between the medium to be transferred and the adhesive layer during transfer, it is preferable that the ink contain a thermoplastic resin.

As a thermoplastic resin used for the aqueous pigment ink from among thermoplastic resins, as described above, a resin emulsion and a water-soluble resin may be employed.

In this embodiment, as the resin emulsion and the water-soluble resin that can be contained in the aqueous pigment ink and the adhesive liquid, those listed as follows are preferable. Resins may be used singly or may also be used in combinations of two or more kinds thereof.

Since such resins need water dispersibility as described above even in a case of water insolubility, a polymer that has both a hydrophilic part and a hydrophobic part, that is, a resin emulsion is preferable. In the case where the resin emulsion is used as the thermoplastic resin, the average particle size thereof is, although not particularly limited as long as it forms an emulsion, preferably smaller than 1 μm, more preferably is equal to or smaller than 150 μm, and even more preferably, is 5 nm to 100 nm.

In addition, in this specification, if not particularly mentioned, the average particle size is measured by a particle size analyzer using a dynamic light scattering method. Pure water is added to an emulsion to dilute the emulsion 100 times and the average particle size is represented as a 50% number-average particle size measured using Nanotrac UPA-EX 150 (manufactured by Nikkiso Co., Ltd.).

As the thermoplastic resin, one that is widely used in an ink jet ink or an adhesive liquid may be used.

Specific examples of the thermoplastic resin used for the aqueous pigment ink may include, although not particularly limited, a (meth)acrylic polymer such as poly(meth)acrylic acid ester or a copolymer thereof, polyacrylonitrile or a copolymer thereof, polycyanoacrylate, polyacrylamide, poly(meth)acrylic acid; a polyolefin-based polymer such as polyethylene, polypropylene, polybutene, polyisobutylene, polystyrene, and copolymers thereof, a petroleum resin, a coumarone-indene resin, and a terpene resin; a vinyl acetate-based or vinyl alcohol-based polymer such as polyvinyl acetate or a copolymer thereof, polyvinyl alcohol, polyvinyl acetal, and polyvinyl ether; a halogen-containing polymer such as polyvinyl chloride or a copolymer thereof, polyvinylidene chloride, a fluororesin, and a fluorine-containing rubber; a nitrogen-containing vinyl-based polymer such as polyvinylcarbazole, polyvinylpyrrolidone or a copolymer thereof, polyvinylpyridine, and polyvinylimidazole; a diene-base polymer such as polybutadiene or a copolymer thereof, polychloroprene, polyisoprene (butyl rubber); an opening polymerization resin; a condensation polymerization resin; and a natural polymer.

Examples of commercially available products of the thermoplastic resin used for the aqueous pigment ink may include Hitec E-7025P, Hitec E-2213, Hitec E-9460, Hitec E-9015, Hitec E-4A, Hitec E-5403 P, and Hitec E-8237 (hereinbefore, trade names all produced by TOHO Chemical Industry Co., Ltd.); AQUACER 507, AQUACER 515, and AQUACER 840 (trade names all produced by BYK-Chemie Japan K.K.); and JONCRYL 67, 611, 678, 680, and 690 (trade names all produced by BASF).

In the case where the thermoplastic resin used for the aqueous pigment ink is obtained in an emulsion state, the thermoplastic resin can be prepared by mixing resin particles with water together with a surfactant as desired. For example, an emulsion of a (meth)acrylic resin or a styrene-(meth)acrylic resin is obtained by mixing a (meth)acrylic acid ester resin or a styrene-(meth)acrylic acid ester resin, a (meth)acrylic acid resin as desired, and a surfactant, with water. It is preferable that the mixing ratio of at least any of the resin emulsion and the water-soluble resin to the surfactant be typically about 50:1 to 5:1 in terms of parts by mass. In a case where the amount of the surfactant used does not reach the range, the emulsion is less likely to be formed. On the other hand, in a case of exceeding the range, there is a tendency to degrade water resistance of the ink or the adhesive liquid or worsen adhesiveness.

Preferable examples of the surfactant include, although not particularly limited, anionic surfactants such as sodium dodecylbenzenesulfonate, sodium lauryl phosphate, and ammonium salts of polyoxyethylene alkyl ether sulfate, nonionic surfactants such as polyoxyethylene alkyl ether, polyoxyethylene alkyl ester, polyoxyethylene sorbitan fatty acid ester, polyoxyethylene alkyl phenyl ether, polyoxyethylene alkyl amine, and polyoxyethylene alkyl amide. Such surfactants may be used singly or by mixing two or more kinds thereof.

In addition, the emulsion of a thermoplastic resin used for the aqueous pigment ink may also be obtained by performing emulsification polymerization of monomers of at least any of the resin emulsions and the water-soluble resins mentioned above in water in the presence of a polymerization catalyst and an emulsifier. The polymerization initiator, the emulsifier, and a molecular weight adjustor used for the emulsification polymerization can be used according to well-known methods.

As the polymerization initiator, those that are used for typical radial polymerization are used. Examples thereof include potassium persulfate, ammonium persulfate, hydrogen peroxide, azobisisobutyronitrile, benzoyl peroxide, dibutyl peroxide, peracetic acid, cumene hydroperoxide, tert-butyl hydroxyperoxide, and paramenthane hydroxyperoxide. In the case where the polymerization reaction is performed in water, a water-soluble polymerization initiator is preferable. Examples of the emulsifier include, besides sodium lauryl sulfate, those generally used as an anionic surfactant, a nonionic surfactant, or a cationic surfactant, and a mixture thereof. They may be used singly or may also be used by mixing two or more kinds thereof.

With regard to a ratio of at least any of the resin emulsion and the water-soluble resin to water, water preferably in a range of 60 parts by mass to 400 parts by mass, and more preferably in a range of 100 parts by mass to 200 parts by mass to 100 parts by mass of the resin is appropriate.

In the case where the resin emulsion is used as the thermoplastic resin, a well-known resin emulsion may also be used. For example, resin emulsions described in JP-B-62-1426, JP-A-3-56573, JP-A-3-79678, JP-A-3-160068, JP-A-4-18462, and the like may be used as they are.

In addition, commercially available resin emulsions may also be used, and examples thereof include: Microgel E-1002 and E-5002 (hereinbefore, trade names produced by Nippon Paint Co., Ltd., a styrene-acrylic resin emulsion); Voncoat 4001 (trade name produced by DIC Corporation, an acrylic resin emulsion), Voncoat 5454 (trade name produced by DIC Corporation, a styrene-acrylic resin emulsion), and JONCRYL 67 (Tg of 73° C.), 611 (Tg of 50° C.), 680 (Tg of 67° C.), 690 (Tg of 102° C.) (hereinbefore, trade names produced by BASF); Polysol AM-710 (Tg of 56° C.), AM-920 (Tg of −20° C.), AM-2300 (Tg of 67° C.), AP-4735(Tg of 21° C.), AT-860(Tg of 60° C.) (hereinbefore, an acrylic resin emulsion), Polysol AP-7020 (Tg of 85° C.) (a styrene-acrylic resin emulsion), and Polysol SH-502 (a polyvinyl acetate resin emulsion, Tg of 30° C.) (hereinbefore, trade names produced by SHOWA DENKO K.K.); SAE1014 (trade name, a styrene-acrylic resin emulsion produced by Zeon Corporation); Saibinol SK-200 (trade name, an acrylic resin emulsion produced by SAIDEN CHEMICAL INDUSTRY CO., LTD.); AE-120A (trade name produced by JSR, an acrylic resin emulsion, Tg of −10° C.); AE373D (trade name produced by Emulsion Technology Co., Ltd., a carboxy-modified styrene-acrylic resin emulsion); Takelac W-6061, (trade name produced by Mitsui Chemicals, Inc., a polyurethane resin emulsion); Seikadain 1900W (trade name produced by Dainichiseika Color & Chemicals Mfg. Co., Ltd., an ethylene-vinyl acetate resin); and Vinyblan 2622 (an acrylic resin emulsion, Tg of −26° C.), 2886 (a vinyl acetate-acrylic resin emulsion, Tg of 0° C.), 5202 (an acetate-acrylic resin emulsion, Tg of 30° C.) (hereinbefore, trade names produced by Nissin Chemical Industry Co., Ltd.).

Of these, as the resin emulsion to be contained in the adhesive liquid, although not particularly limited, one having a glass-transition temperature (Tg) is equal to or higher than 0° C. and equal to or lower than 60° C. is preferable. When Tg is equal to or lower than 60° C., transferability and adhesiveness are excellent. On the other hand, when Tg is equal to or higher than 0° C., blocking resistance is excellent.

In addition, Tg in this embodiment is a value obtained by removing a liquid component from the resin emulsion using heating to extract a resin component and measuring the resin component using a differential thermal thermogravimetric simultaneous measurement apparatus (TG/DTA).

The thermoplastic resin may be mixed with other constituent components in the ink or the adhesive liquid as particle powder. However, it is preferable to mix the thermoplastic resin with other constituent components in the ink or the adhesive liquid after resin particles are dispersed in a water medium to be made into a resin emulsion form. In order to enhance long-term storage stability and discharge stability of the ink or the adhesive liquid, the particle size of the resin particle in this embodiment is preferably in a range of 5 to 400 nm and is more preferably in a range of 50 to 200 nm.

In addition, as the water-soluble resin, a synthetic polymer having alkali metal salts such as a sulfonic acid group, a carboxylic acid group, and an amino group, ammonium salts, inorganic acid salt, and an ionic hydrophilic group such as organic acid salts may be employed. More specifically, a synthetic polymer such as polyethyleneglycol, polyvinylpyrrolidone, polyvinyl alcohol, polyvinyl acetal, and an acrylic resin such as a styrene-(meth)acrylic acid copolymer and a (meth)acrylic acid ester-(meth)acrylic acid copolymer may be employed.

In addition, commercially available water-soluble resins may also be used, and for example, JONCRYL 678 and 680 (hereinbefore, trade names produced by BASF, an acrylic resin), and Denka POVAL H-12 (trade name produced by Denki Kagaku Kogyo K.K., polyvinyl alcohol) may be employed.

Any of the resin emulsion and the water-soluble resin is preferably contained in a range of 0.5 to 10.0 mass % to the total mass (100 mass %) of the ink or the adhesive liquid in terms of solid content. When the content of such a resin is too small, a coating of the ink or the adhesive liquid formed on the surface of the base material is thinned, resulting in insufficient adhesiveness with the surface of the base material. When the content of such a resin is too high, there may be cases where discharge stability of the ink or the adhesive liquid is degraded, dispersion of the resin during storage of the ink or the adhesive liquid becomes unstable, or the resin is agglutinated and solidifies due to evaporation of a little water and uniform coatings cannot be formed.

On the other hand, examples of the thermoplastic resin used for the non-aqueous pigment ink include an acrylic resin, a styrene-acrylic resin, a rosin modified resin, a terpene-based resin, a polyester resin, a polyamide resin, an epoxy resin, a vinyl chloride resin, a vinyl chloride-vinyl acetate copolymer, a cellulose-based resin (for example, cellulose acetate butyrate, and hydroxypropylcellulose), polyvinyl butyral, polyacryl polyol, polyvinyl alcohol, and polyurethane.

In addition, non-aqueous emulsion type polymer particles may be used as the thermoplastic resin. That is a dispersion liquid in which particles such as a polyurethane resin, an acrylic resin, or an acryl polyol resin are stably dispersed in an organic solvent. As the polyurethane resin, for example, SANPRENE IB-501 and SANPRENE IB-F370 produced by Sanyo Chemical Industries, Ltd. may be employed. As the acryl polyol resin, for example, N-2043-60 MEX produced by Harima Chemicals, Inc. may be employed.

In order to enhance adhesiveness, it is preferable that 0.1 to 10 mass % of the resin emulsion to the total mass (100 mass %) of the non-aqueous pigment ink be contained. When the content thereof is equal to or higher than 0.1 mass %, discharge stability is enhanced. When the content thereof is equal to or lower than 10 mass %, adhesiveness is enhanced.

The thermoplastic resin in the non-aqueous pigment ink is preferably at least one kind selected from the group consisting of polyvinyl butyral, cellulose acetate butyrate, and polyacryl polyol and is more preferably cellulose acetate butyrate. By employing such appropriate configurations, fixability is excellent.

Water-Soluble Organic Solvent with Boiling Point of 250° C. or Less at 1 atm

By containing a water-soluble organic solve having a boiling point of 250° C. or less at 1 atm (more preferably, equal to or higher than 70° C. and equal to or lower than 250° C.) in the ink (an aqueous pigment ink or a non-aqueous pigment ink) or the adhesive liquid, the resin in the ink or the adhesive liquid can be stabilized, such that discharge stability and volatility of the ink or the adhesive liquid become excellent and thus transfer unevenness of an image can be effectively prevented.

Due to excellent discharge stability, the water-soluble organic solvent is preferably an aqueous liquid containing one or more kinds selected from the group consisting of lactam, carboxylic acid ester, alkylene glycol ether, and alcohol. Of these, an aqueous liquid containing 2-pyrrolidone (γ-butyrolactam), lactic acid ester, alkylene glycol ether, and alcohol is more preferable.

Examples of the water-soluble organic solvent include, although not particularly limited, ethanol (boiling point of 78° C.), N-methyl-2-pyrrolidone (boiling point of 204° C.), N-ethyl-2-pyrrolidone (boiling point of 212° C.), 2-pyrrolidone (boiling point of 245° C.), dimethylsulfoxide (boiling point of 189° C.), methyl lactate (boiling point of 145° C.), ethyl lactate (boiling point of 155° C.), isopropyl lactate (boiling point of 168° C.), butyl lactate (boiling point of 188° C.), ethylene glycol monomethyl ether (boiling point of 124° C.), ethylene glycol dimethyl ether (boiling point of 85° C.), ethylene glycol monomethyl ether acetate (boiling point 145° C.), diethylene glycol monomethyl ether (boiling point of 194° C.), diethylene glycol monopropyl ether (boiling point of 212° C.), diethylene glycol monobutyl ether (boiling point of 230° C.), diethylene glycol dimethyl ether (boiling point of 162° C.), diethylene glycol ethyl methyl ether (boiling point of 176° C.), diethylene glycol diethyl ether (boiling point of 189° C.), triethylene glycol monomethyl ether (boiling point of 249° C.), propylene glycol monomethyl ether (boiling point of 120° C.), propylene glycol dimethyl ether (boiling point of 97° C.), dipropylene glycol monomethyl ether (boiling point of 188° C.), dipropylene glycol dimethyl ether (boiling point of 171° C.), 1,4-dioxane (boiling point of 101° C.), ethylene glycol (boiling point of 197° C.), diethylene glycol (boiling point of 244° C.), propylene glycol (boiling point of 188° C.), dipropylene glycol (boiling point of 232° C.), 1,3-propanediol (boiling point of 212° C.), 1,4-butanediol (boiling point of 230° C.), hexylene glycol (boiling point of 198° C.), 2,3-butanediol (boiling point of 77° C.), n-butanol (boiling point of 118° C.), 1,2-hexanediol (boiling point of 224° C.), and 1,2-pentanediol (boiling point of 206° C.)

The water-soluble organic solvents having boiling points of equal to or lower than 250° C. at 1 atm may be used singly or used by mixing two or more kinds thereof.

### Surfactant

In this embodiment, as the surfactant used for the ink, surfactants made of one or more kinds selected from the group consisting of acetylene glycol-based surfactants and silicone-based surfactants.

Examples of the acetylene glycol-based surfactant include 2,4,7,9-tetramethyl-5-decyne-4,7-diol, 3,6-dimethyl-4-octyne-3,6-diol, 3 5-dimethyl-1-hexyn-3-ol, and 2,4-dimethyl-5-hexyn-3-ol. As commercially available products of the acetylene glycol-based surfactants, for example, Olfine E1010, STG, and Y, and Surfynol 104E, 104H, 104A, 104BC, 104DPM, 104PA, 104PG-50, 104S, 420, 465, 485, TG, SE, SE-F, 61, 82, and DF-110D (hereinbefore, trade names all produced by Nissin Chemical Industry Co., Ltd., Acetylenol E00 and E00P (hereinbefore, trade names all produced by Kawaken Fine Chemicals Co., Ltd. may be used.

A polysiloxane compound is preferably used as the silicone-based surfactant. A specific example of the polysiloxane compound includes polyether-modified organosiloxanes. As commercially available products of the silicone-based surfactants, BYK-306, BYK-307, BYK-333, BYK-341, BYK-345, BYK-346, BYK-347, BYK-348, and BYK-UV3500, 3510, 3530, and 3570 (trade names all produced by BYK-Chemie Japan K.K. may be used.

A particularly preferable surfactant is a combination of the silicone-based surfactant and the acetylene glycol-based surfactant having an HLB value of equal to or less than 17.

In addition, the surface tension of the ink is caused to be preferably in a range of 23.0 mN/m to 40.0 mN/m by combining the water-soluble organic solvent described above with the surfactant and more preferably in a range of 25.0 mN/m to 35.0 mN/m. When the surface tension of the ink is within the range, discharge stability is excellent.

### Polymerizable Compound

Monomers and oligomers that are polymerizable components that can be contained in the UV-curable pigment ink are not particularly limited as long as they are components that are polymerized and solidify during illumination of light such as UV rays by an action of a photopolymerization initiator described later, and various kinds of monomers and oligomers having monofunctional groups, bifunctional groups, polyfunctional groups of tri- or higher functional groups may be used.

Here, in this embodiment, “monomer” means a molecule having a number-average molecular weight of 100 to 3,000. In this embodiment, “oligomer” means a molecule having a number-average molecular weight of 500 to 20,000. Moreover, in this embodiment, the number-average molecular weight is measured according to gel permeation chromatography (GPC).

Examples of the monomer include unsaturated carboxylic acids such as (meth)acrylic acid, itaconic acid, crotonic acid, isocrotonic acid, and maleic acid and salts or esters thereof, urethane, amide and anhydrides thereof, acrylonitrile, styrene, various unsaturated polyesters, unsaturated polyether, unsaturated polyamide, and unsaturated urethane.

Examples of the oligomer include oligomers formed from the monomers such as straight-chained acrylic oligomers, epoxy (meth)acrylate, urethane (meth)acrylate, and polyester (meth)acrylate.

In addition, the monomers and the oligomers may also be allyl compounds. The allyl compounds are compounds having a 2-propenyl (—CH₂CH═CH₂) structure. A 2-propenyl group is also called an allyl group, and is a common name according to IUPAC Nomenclature. The allyl compound has radical polymerizability. Specific examples of the allyl compound include ethylene glycol monoallyl ether, allyl glycol (that can be obtained from, for example, Nippon Nyukazai Co., Ltd.), trimethylolpropane diallyl ether, pentaerythritol triallyl ether, and glycerin monoallyl ether (hereinbefore, can be obtained from, for example, DAISO), and polyoxyalkylene compounds having allyl group such as trade names UNIOX, UNILUB, POLYCERIN, and UNISAFE (that can be obtained from NOF CORPORATION).

Of these, allyl glycol is preferably used. By using allyl glycol as the polymerizable compound, the UV-curable ink can be caused to have a low viscosity and thus can be adjusted to an optimal viscosity (equal to or lower than 10 mPa·s at 25° C.) for the ink used in the production method of this embodiment.

In addition, the monomers and the oligomers may be N-vinyl compounds. As the N-vinyl compounds, there are N-vinylformamide, N-vinylcarbazole, N-vinylacetamide, N-vinylpyrrolidone, N-vinylcaprolactam, acryloyl morpholine, derivatives thereof, and the like.

### Photopolymerization Initiator

The photopolymerization initiator that can be contained in the UV-curable pigment ink is not limited as long as it generates active species such as radicals or cations by energy of light such as UV rays and initiates polymerization of the polymerizable compounds. A radical photopolymerization initiator or a cationic photopolymerization initiator may be used, and of these, it is preferable to use the radical photopolymerization initiator.

Examples of the radical photopolymerization initiator include aromatic ketones, an acylphosphine compound, an aromatic onium salt compound, organic peroxide, a thio compound, a hexaarylbiimidazole compound, a ketoxime ester compound, a borate compound, an azinium compound, a metallocene compound, an active ester compound, a compound having a carbon-halogen bond, and an alkylamine compound.

Specific examples of the radical photopolymerization initiator include acetophenone, acetophenone benzyl ketal, 1-hydroxycyclohexylphenylketone, 2,2-dimethoxy-2-phenylacetophenone, xanthone, fluorenone, benzaldehyde, fluorine, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyldimethylketal, 1-(4-isopropylphenyl)-2-hydroxy-2-methylpropane-1-one, 2-hydroxy-2-methyl-1-phenylpropan-1-one, thioxanthone, diethylthioxanthone, 2-isopropylthioxanthone, 2-chlorothioxanthone, 2-methyl-1-[4-(methylthio)phenyl]-2-morpholino-propan-1-one, bis(2,4,6-trimethylbenzoyl)-phenylphosphineoxide, 2,4,6-trimethylbenzoyldiphenylphosphineoxide, 2,4-diethylthioxanthone, and bis-(2,6-dimethoxybenzoyl)-2,4,4-trimethylpentylphosphine oxide.

Examples of commercially vailable products of the radical photopolymerization initiator include: IRGACURE 651 (2,2-dimethoxy-1,2-diphenylethane-1-one), IRGACURE 184 (1-hydroxy-cyclohexyl-phenyl-ketone), DAROCUR 1173 (2-hydroxy-2-methyl-1-phenyl-propane-1-one), IRGACURE 2959 (1-[4-(2-hydroxyethoxy)-phenyl]-2-hydroxy-2-methyl-1-propane-1-one), IRGACURE 127 (2-hydroxy-1-{4-[4-(2-hydroxy-2-methyl-propionyl)-benzyl]phenyl]-2-methyl-propane-1-one}), IRGACURE 907 (2-methyl-1-(4-methylthiophenyl)-2-morpholinopropane-1-one), IRGACURE 369 (2-benzyl-2-dimethylamino-1-(4-morpholinophenyl)-butanone-1), IRGACURE 379 (2-dimethylamino-2-[(4-methylphenyl)methyl]-1-[4-(4-morpholinyl)phenyl]-1-butanone), DAROCUR TPO (2,4,6-trimethylbenzoyl-diphenyl-phosphine oxide), IRGACURE 819 (bis(2,4,6-trimethylbenzoyl)-phenyl phosphine oxide), IRGACURE 784 (bis(η⁵-2,4-cyclopentadien-1-yl)-bis(2,6-difluoro-3-(1H-pyrrol-1-yl)-phenyl)titanium), IRGACURE OXE 01 (1,2-octandione, 1-[4-(phenylthio)-,2-(O-benzoyloxime)]), IRGACURE OXE 02 (ethanone, 1-[9-ethyl-6-(2-methylbenzoyl)-9H-carbazol-3-yl]-,1-(O-acetyloxime)), and IRGACURE 754 (a compound of oxyphenylacetic acid, 2-[2-oxo-2-phenylacetoxyethoxy]ethyl ester and oxyphenylacetic acid, 2-(2-hydroxyethoxy)-ethyl ester) (hereinbefore, produced by Ciba Japan K.K.); DETX-S (2,4-diethylthioxanthone) (produced by Nippon Kayaku Co., Ltd.); Lucirin TPO, LR8893, and LR8970 (hereinbefore, produced by BASF); and Ebecryl P36 (produced by UCB Chemicals, Inc.).

The photopolymerization initiators may be used singly or used in combinations of two or more kinds thereof.

In addition, by using photopolymerizable compounds as the polymerizable compounds described above, addition of the photopolymerization initiators can be omitted. However, using the photopolymerization initiators is preferable as polymerization initiation can be easily adjusted.

### Polymerization Inhibitor

As a polymerization inhibitor that can be obtained in the UV-curable pigment ink, although not particularly limited, for example, IRGASTAB UV10 and UV22 (produced by BASF) can be used. By adding the polymerization inhibitor, storage stability of ink compositions can be enhanced.

### Water

Water is a main solvent in the case where the ink used in this embodiment is an aqueous ink and is also contained in the adhesive liquid. It is preferable that, in order to contain as few ionic impurities as possible, as the water, pure water or ultrapure water such as ion-exchange water, ultrafiltration water, reverse osmosis water, or distilled water be used. In addition, when water sterilized by UV illumination, addition of hydrogen peroxide, or the like is used, generation of mold or bacteria can be prevented in a case of long-term storage of a pigment dispersion liquid or ink using this, which is preferable.

In addition, the main solvent refers to a solvent having a highest content from among all solvents in the ink.

### Other Additives

The ink or the adhesive liquid in this embodiment may further contain a preservative, a fungicide, a pH adjuster, an antioxidant, an organic solvent other than those described above, a metal trapping agent, and the like, if necessary.

Examples of the preservative and fungicide include sodium benzoate, sodium pentachlorophenol, sodium 2-pyridinethiol-1-oxide, sodium sorbate, sodium dehydroacetate, and 1,2-dibenzisothiazolin-3-one (Proxel-CRL, Proxel-BDN, Proxel-GXL, Proxel-XL2, and Proxel-TN produced by Arch Chemicals).

Examples of the pH-adjuster include inorganic alkalis such as sodium hydroxide or potassium hydroxide, ammonia, diethanolamine, triethanolamine, triisopropanolamine, morpholine, potassium dihydrogen phosphate, and disodium hydrogen phosphate.

As the metal trapping agent, for example, there is disodium ethylenediaminetetraacetate.

As such, according to this embodiment, discharge stability when the ink for colored layer formation and the adhesive liquid for adhesive layer formation are discharged from the ink jet head is excellent, and the pattern of the colored layer can be obtained with high resolution. Therefore, transferability is excellent and the production method of a transfer medium having excellent adhesiveness after transfer can be provided.

### Transfer Medium

The embodiment of the invention is related to a transfer medium. The transfer medium can be obtained by performing the production method of the embodiment. The transfer medium has a colored layer and an adhesive layer laminated on a base material in this order, and as needed, has a protective layer or a release layer between the base material and the colored layer or has the release layer and the protective layer laminated in this order between the base material and the colored layer from the base material side.

With regard to the transfer medium, the thickness of the colored layer is, although not particularly limited, preferably 1 to 10 μm and more preferably 2 to 5 μm. As the thickness of the colored layer is within the range, color developing properties are excellent. In addition, the thickness of the adhesive layer is, although not particularly limited, preferably 0.5 to 5 μm and more preferably 1 to 3.5 μm. As the thickness of the adhesive layer is within the numerical value range, adhesiveness is excellent.

Moreover, in the case where the transfer medium has the protective layer 91, the thickness of the protective layer 91 is preferably 10 to 30 μm. As the thickness of the protective layer 91 is within the range, the transfer medium does not become bulky in the case where the base material having a roll form is used or is excellent in terms of protection of the colored layer 81 or production costs of the protective layer 91.

### Transferred Matter

This embodiment of the invention is related to a transferred matter, and the transferred matter is obtained by performing transfer from the transfer medium of this embodiment to the medium to be transferred. Examples of the transferred matter include plastic and metal used in the interior of a vehicle, the exterior of a notebook, the exterior of a portable phone, a cosmetic container, stationery products, and the like. Examples of the medium (material) to be transferred include plastic such as an acrylic resin, a polyester resin, a polypropylene resin, and an ABS resin, and metal such as nickel, iron, SUS, and titanium.

### EXAMPLES

Hereinafter, the embodiment of the invention will be more specifically described on the basis of Examples, and the embodiment of the invention is not limited only to the Examples.

### Example A

### Preparation of Aqueous Pigment Ink A

An aqueous pigment ink interchangeable-lens system camera for colored layer formation (hereinafter, simply referred to as “ink A1”) was prepared.

### Ink A1-1

4 parts by mass of diethylene glycol monobutyl ether (hereinafter, also referred to as “DEGmBE”), 1 part by mass of BYK-348 (a silicone-based surfactant, trade name produced by BYK-Chemie Japan K.K.), and 30 parts by mass of ion-exchange water were mixed, and agitated at room temperature for 20 minutes, thereby obtaining a preliminary mixed liquid. Next, 5 parts by mass of JONCRYL 678 (an acrylic water-soluble resin, trade name produced by BASF, with a molecular weight of 8500, and an acid number of 215) as a water-soluble resin, and 0.1 parts by mass of potassium hydroxide (KOH) as a pH-adjuster were added to the preliminary mixed liquid, and the resultant was agitated at 40° C. for 1 hour.

To the liquid after the agitation, 10 parts by mass of carbon black MA100 (trade name produced by Mitsubishi Chemical Corporation) was added to obtain a mixed liquid, and the mixed liquid is agitated together with zirconia glass beads (with a diameter of 1.5 mm) having a mass of 1.5 times the mass of the mixed liquid in a desktop sand mill (produced by Hayashi Shoten) at 2160 rpm for 2 hours so as to be dispersed. After the dispersion, the resultant is filtered by a SUS mesh filter with a diameter of 0.1 mm, thereby preparing a dispersion liquid.

To the dispersion liquid, 2-pyrrolidone (hereinafter, also referred to as “2-Py”), propylene glycol (hereinafter, also referred to as “PG”), Polysol AM-710 (an acrylic resin emulsion, trade name produced by SHOWA DENKO K.K., with an average particle size of 150 nm and an active ingredient of 50.5%) as a resin emulsion, Proxel-XL2 (a preservative, trade name produced by Arch Chemicals), and ion-exchange water were added by amounts (parts by mass) shown in Table 1, and the resultant was agitated at 40° C. for 20 minutes. After the agitation, the resultant was filtered by a membrane filter having a diameter of 5 μm, thereby preparing a black ink A1-1 of which the composition is shown in Table 1.

### Ink A1-2

3 parts by mass of DEGmBE, 0.5 parts by mass of BYK-348, and 30 parts by mass of ion-exchange water were mixed, and agitated at room temperature for 20 minutes, thereby obtaining a preliminary mixed liquid. Next, 2 parts by mass of JONCRYL 680 (an acrylic water-soluble resin, trade name produced by BASF, with a molecular weight of 4900, and an acid number of 215) as a water-soluble resin, and 0.1 mass % of KOH were added to the preliminary mixed liquid, and the resultant was agitated at 40° C. for 1 hour.

To the liquid after the agitation, 5 parts by mass of a cyan pigment (C.I. Pigment Blue 15:3, produced by DIC Corporation) was added to obtain a mixed liquid, and thereafter, the resultant was subjected to dispersion and filtration under the same conditions as those of the case of the ink A1-1, thereby preparing a dispersion liquid.

To the dispersion liquid, 1,2-hexanediol (hereinafter, also referred to as “1,2-HD”), 2-Py, PG, Polysol AM-2300 (a styrene-acrylic resin emulsion, trade name produced by SHOWA DENKO K.K., with a minimum film forming temperature (MFT) of 70° C., an average particle size of 90 nm, and an active ingredient of 40%) as a resin emulsion, Proxel-XL2, and ion-exchange water were added by amounts (parts by mass) shown in Table 1, and thereafter, the resultant was agitated and filtered under the same conditions as those of the case of the ink A1-1, thereby preparing a cyan ink A1-2 of which the composition is shown in Table 1.

### Ink A1-3

3 parts by mass of DEGmBE, 0.8 parts by mass of BYK-348, and 30 parts by mass of ion-exchange water were mixed, and agitated at room temperature for 20 minutes, thereby obtaining a preliminary mixed liquid. Next, 1 part by mass of JONCRYL 680 and 0.1 mass % of KOH were added to the preliminary mixed liquid, and the resultant was agitated at 40° C. for 1 hour.

To the liquid after the agitation, 4 parts by mass of a magenta pigment (C.I. Pigment Red 122, produced by BASF) was added to obtain a mixed liquid, and thereafter, the resultant was subjected to dispersion and filtration under the same conditions as those of the case of the ink A1-1, thereby preparing a dispersion liquid.

To the dispersion liquid, 1,2-HD, 2-Py, PG, AE373D (a carboxy-modified styrene-acrylic resin emulsion, trade name produced by Emulsion Technology Co., Ltd., with an average particle size of 150 nm, and an active ingredient of 50%), Proxel-XL2, and ion-exchange water were added by amounts (parts by mass) shown in Table 1, and thereafter, the resultant was agitated and filtered under the same conditions as those of the case of the ink A1-1, thereby preparing a magenta ink A1-3 of which the composition is shown in Table 1.

### Ink A1-4

3 parts by mass of DEGmBE, 0.8 parts by mass of BYK-348, and 30 parts by mass of ion-exchange water were mixed, and agitated at room temperature for 20 minutes, thereby obtaining a preliminary mixed liquid. Next, 2 parts by mass of JONCRYL 680 and 0.1 mass % of KOH were added to the preliminary mixed liquid, and the resultant was agitated at 40° C. for 1 hour.

To the liquid after the agitation, 4 parts by mass of a yellow pigment (C.I. Pigment Yellow 180, produced by Dainichiseika Color & Chemicals Mfg. Co., Ltd.) as a resin emulsion was added to obtain a mixed liquid, and thereafter, the resultant was subjected to dispersion and filtration under the same conditions as those of the case of the ink A1-1, thereby preparing a dispersion liquid.

To the dispersion liquid, 1,2-HD, 2-Py, PG, Polysol AT860 (an acrylic resin emulsion, trade name produced by SHOWA DENKO K.K., with an average particle size of 120 nm, Tg of 60° C., and an active ingredient of 50%), Surfynol 465 (an acetylene glycol-based surfactant, trade name produced by Air Products and Chemicals Inc.), Proxel-XL2, and ion-exchange water were added by amounts (parts by mass) shown in Table 1, and thereafter, the resultant was agitated and filtered under the same conditions as those of the case of the ink A1-1, thereby preparing a yellow ink A1-4 of which the composition is shown in Table 1.

### Ink A1-5

1 parts by mass of BYK348, 4.7 parts by mass of Denka POVAL H-12 (polyvinyl alcohol, trade name produced by Denki Kagaku Kogyo K.K., with a pure content of 94%) as a water-soluble resin, and 30 parts by mass of ion-exchange water were mixed, and agitated at 40° C. for 1 hour.

To the liquid after the agitation, 9.5 parts by mass of CR-50 (rutile type titanium oxide, trade name produced by ISHIHARA SANGYO KAISHA, LTD., with a TiO₂ active ingredient of 95%, and an average particle size of 0.25 μm) as a pigment was added to obtain a mixed liquid, and thereafter, the resultant was subjected to dispersion and filtration under the same conditions as those of the case of the ink A1-1, thereby preparing a dispersion liquid.

To the dispersion liquid, Takelac W-6061, (a polyurethane resin emulsion, trade name produced by Mitsui Chemicals, Inc., with a solid content of 30%), 1,2-HD, 2-Py, PG, Proxel-XL2, and ion-exchange water were added by amounts (parts by mass) shown in Table 1, and the resultant was agitated at 40° C. for 20 minutes. After the agitation, the resultant was filtered by a SUS mesh filter with a diameter of 10 μm, thereby preparing a white ink A1-5 of which the composition is shown in Table 1.

The compositions of the ink A1-1 to the ink A1-5 are collected in Table 1. In addition, in Table 1, “Resin EM” means a resin emulsion, and empty fields mean no addition. The molecular weight of ion-exchange water is the molecular weight of the ion-exchange water contained in the obtained ink.

TABLE 1

| | | Resin | | Water-Soluble Organic | | | | | | | | | |
|---|---|---|---|---|---|---|---|---|---|---|---|---|---|
| | | Water- | | Solvent with Intermediate | | | | Surfactant | | pH- | | Ion- | |
| | | Soluble | Resin | Boiling Point | | | | BYK- | Surfynol | adjuster | Preservative | Exchange | |
| | Pigment | Resin | EM | DEGmBE | 1,2-HD | 2-Py | PG | 348 | 465 | KOH | Proxel-XL2 | water | Total |
| Ink A-1 | 10 | 5 | 0.5 | 4 | | 4 | 1 | 1 | | 0.1 | 0.2 | 74.2 | 100 |
| Ink A-2 | 5 | 2 | 13 | 3 | 4 | 3 | 12 | 0.5 | | 0.1 | 0.2 | 57.2 | 100 |
| Ink A-3 | 4 | 1 | 0.5 | 3 | 4 | 3 | 12 | 0.8 | | 0.1 | 0.2 | 71.4 | 100 |
| Ink A-4 | 4 | 2 | 0.6 | 3 | 10 | 5 | 5 | 0.8 | 1.2 | 0.1 | 0.2 | 68.1 | 100 |
| Ink A-5 | 9.5 | 4.7 | 4 | | 5 | 4 | 5 | 1 | | | 0.2 | 66.6 | 100 |

### Preparation of UV-Curable Pigment Ink B1

A UV-curable pigment ink B1 for colored layer formation (hereinafter, simply referred to as “ink B1”) was prepared.

### Ink B1-1

14 parts by mass of allyl glycol (a monomer produced by Nippon Nyukazai Co., Ltd., hereinafter, also referred to as “AG”) and 1.2 parts by mass of Discole N-509 (a dispersant, polyoxyalkylene polyalkylene polyamine, trade name produced by Dainichiseika Color & Chemicals Mfg. Co., Ltd.) were mixed, and agitated at 40° C. for 20 minutes.

To the liquid after the agitation, 6 parts by mass of carbon black MA7 (trade name produced by Mitsubishi Chemical Corporation) was added to obtain a mixed liquid, and the mixed liquid is agitated together with zirconia glass beads (with a diameter of 1.5 mm) having a mass of 1.5 times the mass of the mixed liquid in a desktop sand mill (produced by Hayashi Shoten) at 2160 rpm for 2 hours so as to be dispersed. After the dispersion, the resultant is filtered by a SUS mesh filter with a diameter of 0.1 mm, thereby preparing a dispersion liquid.

To the dispersion liquid, N-methyl-2-pyrrolidone (hereinafter, also referred to as “NMP”), U-15HA (a urethane acrylate oligomer, trade name produced by Shin-Nakamura Chemical Co., Ltd., with a weight-average molecular weight of 2300), Irgacure 127 and 819 (a photopolymerization initiator, hereinbefore, trade names produced by BASF), Irgastab UV-10 (a polymerization inhibitor, trade name produced by BASF), BYK-UV3500 (a surfactant, trade name produced by BYK-Chemie Japan K.K.), and AG (residue) were added by amounts (parts by mass) shown in Table 2, and the resultant was agitated at room temperature for 1 hour. After the agitation, the resultant was filtered by a membrane filter having a diameter of 5 μm, thereby preparing a black ink B1-1 of which the composition is shown in Table 2. In addition, in 10 parts by mass of the photopolymerization initiator in Table 2, there are 7 parts by mass of Irgacure 127 and 3 parts by mass of Irgacure 819.

### Ink B1-2

A dispersion liquid was prepared in the same manner as during the preparation of the ink B1-1 except that carbon black which is a colorant was used as a cyan pigment (C.I. Pigment Blue 15:4, produced by DIC Corporation) and the composition was as shown in FIG. 2. In addition, during preparation of this dispersion liquid, 14 parts by mass of AG was added.

To the dispersion liquid, N-vinylformamide (hereinafter, also referred to as “NVF”) as a monomer, U-15HA, Irgacure 127 and 819, Irgastab UV-10, BYK-UV3500, and AG (residue) were added by amounts (parts by mass) shown in Table 2, and the resultant was agitated at room temperature for 1 hour. After the agitation, the resultant was filtered by a membrane filter having a diameter of 5 μm, thereby preparing a cyan ink B1-2 of which the composition is shown in Table 2. In addition, in 69.8 parts by mass of the monomer in Table 2, there are 59.8 parts by mass of AG and 10 parts by mass of NVF. In addition, in 5 parts by mass of the photopolymerization initiator in Table 2, there are 3 parts by mass of Irgacure 127 and 2 parts by mass of Irgacure 819.

### Ink B1-3

A dispersion liquid was prepared in the same manner as during the preparation of the ink B1-1 except that carbon black which is a colorant was used as a magenta pigment (C.I. Pigment Violet 19, produced by BASF) and the composition was as shown in FIG. 2. In addition, during preparation of this dispersion liquid, 14 parts by mass of AG was added.

To the dispersion liquid, 2-Py, U-15HA, Irgacure 127 and 819, Irgastab UV-10, BYK-UV3500, AG (residue), and ion-exchange water were added by amounts (parts by mass) shown in Table 2, and the resultant was agitated at room temperature for 1 hour. After the agitation, the resultant was filtered by a membrane filter having a diameter of 5 μm, thereby preparing a magenta ink B1-3 of which the composition is shown in Table 2. In addition, in 3 parts by mass of the photopolymerization initiator in Table 2, there are 2 parts by mass of Irgacure 127 and 1 parts by mass of Irgacure 819.

### Ink B1-4

A dispersion liquid was prepared in the same manner as during the preparation of the ink B1-1 except that carbon black which is a colorant was used as a yellow pigment (C.I. Pigment Yellow 150, produced by Win chemicals Ltd.) and the composition was as shown in FIG. 2. In addition, during preparation of this dispersion liquid, 14 parts by mass of AG was added.

To the dispersion liquid, 2-Py, U-15 HA, Irgacure 127 and 819, Irgastab UV-10, BYK-UV3500, and AG (residue) were added by amounts (parts by mass) shown in Table 2, and the resultant was agitated at room temperature for 1 hour. After the agitation, the resultant was filtered by a membrane filter having a diameter of 5 μm, thereby preparing a yellow ink B1-4 of which the composition is shown in Table 2. In addition, in 5 parts by mass of the photopolymerization initiator in Table 2, there are 3 parts by mass of Irgacure 127 and 2 parts by mass of Irgacure 819.

### Ink B1-5

A dispersion liquid was prepared in the same manner as during the preparation of the ink B1-1 except that carbon black which is a colorant was used as a cyan pigment (C.I. Pigment Blue 15:4, produced by DIC Corporation) and the composition was as shown in FIG. 2. In addition, during preparation of this dispersion liquid, 14 parts by mass of AG was added.

To the dispersion liquid, N-vinylformamide (hereinafter, also referred to as “NVF”) as a monomer, U-15HA, Irgacure 127 and 819, Irgastab UV-10, BYK-UV3500, and AG (residue) were added by amounts (parts by mass) shown in Table 2, and the resultant was agitated at room temperature for 1 hour. After the agitation, the resultant was filtered by a membrane filter having a diameter of 5 μm, thereby preparing a cyan ink B1-5 of which the composition is shown in Table 2. In addition, in 44.4 parts by mass of the monomer in Table 2, there are 34.4 parts by mass of AG and 10 parts by mass of NVF. In addition, in 5 parts by mass of the photopolymerization initiator in Table 2, there are 3 parts by mass of Irgacure 127 and 2 parts by mass of Irgacure 819.

### Ink B1-6

A dispersion liquid was prepared in the same manner as during the preparation of the ink B1-1 except that carbon black which is a colorant was used as a magenta pigment (C.I. Pigment Violet 19, produced by BASF) and the composition was as shown in FIG. 2. In addition, during preparation of this dispersion liquid, 14 parts by mass of AG was added.

To the dispersion liquid, 2-Py, U-15HA, Irgacure 127 and 819, Irgastab UV-10, BYK-UV3500, AG (residue), and ion-exchange water were added by amounts (parts by mass) shown in Table 2, and the resultant was agitated at room temperature for 1 hour. After the agitation, the resultant was filtered by a membrane filter having a diameter of 5 μm, thereby preparing a magenta ink B1-6 of which the composition is shown in Table 2. In addition, in 3 parts by mass of the photopolymerization initiator in Table 2, there are 2 parts by mass of Irgacure 127 and 1 parts by mass of Irgacure 819.

The compositions of the ink B1-1 to the ink B1-6 are collected in Table 2. In addition, in Table 2, the molecular weight of a monomer is the molecular weight of a monomer contained in the obtained ink. Empty fields mean no addition.

TABLE 2

| | | | | Water-Soluble Organic | | | | | | | |
|---|---|---|---|---|---|---|---|---|---|---|---|
| | | Polymerizable | | Solvent with Intermediate | | | | Polymerization | | Ion- | |
| | | Compound | | Boiling Point | | Dispersant | Surfactant | Inhibitor | Photopolymerization | Exchange | |
| | Pigment | Monomer | Oligomer | NMP | 2-Py | N-509 | UV3500 | UV-10 | Initiator | water | Total |
| Ink | 6 | 42.4 | 20 | 20 | | 1.2 | 0.2 | 0.2 | 10 | | 100 |
| B-1 | | | | | | | | | | | |
| Ink | 4 | 69.8 | 20 | | | 0.8 | 0.2 | 0.2 | 5 | | 100 |
| B-2 | | | | | | | | | | | |
| Ink | 5 | 70 | 10.6 | | 7 | 1 | 0.2 | 0.2 | 3 | 3 | 100 |
| B-3 | | | | | | | | | | | |
| Ink | 10 | 62.6 | 10 | | 10 | 2 | 0.2 | 0.2 | 5 | | 100 |
| B-4 | | | | | | | | | | | |
| Ink | 0.2 | 44.4 | 50 | | | 0.04 | 0.2 | 0.2 | 5 | | 100 |
| B-5 | | | | | | | | | | | |
| Ink | 0.5 | 30 | 50 | | 7 | 0.1 | 0.2 | 0.2 | 3 | 9 | 100 |
| B-6 | | | | | | | | | | | |

### Preparation of Non-Aqueous Pigment Ink C

A non-aqueous pigment ink C for colored layer formation (hereinafter, simply referred to as “ink C”) was prepared.

### Ink C1-1

Onto a PET film having a film thickness of 100 μm, a resin layer coating liquid made of 5.0 parts by mass of cellulose acetate butyrate (a butylation ratio of 35 to 39%, produced by Kanto Chemical Co., Inc.) and 95.0 mass % of diethylene glycol diethyl ether (produced by Nippon Nyukazai Co., Ltd.) was applied by a spin coating method, and the resultant was dried, thereby forming a resin layer having a thickness of 10 μm on the PET film. In addition, as for the condition of the spin coating method, rotation was performed at 500 rpm for 10 seconds, and thereafter rotation was performed at 2000 rpm for 30 seconds. In addition, as for the condition of the drying, the drying was performed at 100° C. for 30 minutes. The thickness of the obtained resin layer was 10 μm.

Next, using a VE-1010 vacuum deposition apparatus (produced by VACUUM DEVICE INC.) as a vacuum deposition apparatus, an aluminum deposition layer having an average film thickness of 20 nm was formed on the resin layer, thereby obtaining a laminated body.

Next, the laminated body was subjected to peeling, size reduction, and dispersion treatments at the same time in diethylene glycol diethyl ether using a VS-150 ultrasonic disperser (produced by AS ONE Corporation), thereby producing an aluminum pigment dispersion liquid of which an ultrasonic dispersion treatment time (integration value) is 12 hours.

The obtained aluminum pigment dispersion liquid was subjected to a filtration treatment by a SUS mesh filter having an opening of 5 μm, thereby removing coarse particles. Subsequently, the filtered liquid was put into a round-bottom flask and diethylene glycol diethyl ether was distilled using a rotary evaporator. Accordingly, the aluminum pigment dispersion liquid was condensed, and thereafter, concentration adjustment of the metallic pigment dispersion liquid was performed, thereby obtaining an aluminum pigment dispersion liquid having a pigment concentration of 5 mass %.

Using a particle size and particle shape distribution measurement apparatus (FPIA-30005 produced by Sysmex), an average particle size R50 of cumulated 50% of diameters of equivalent circles, which is obtained from a cumulative curve in which the entire area of the aluminum pigment group was 100%, was calculated and obtained as 1.0 μm.

Here, the “diameter of the equivalent circle” means the diameter of a circle having the same area as a projected area of the substantially flat surface (X-Y plane) of a flat plate-shaped particle of the aluminum pigment. Here, the “substantially flat surface” means a surface of which the projected area of the corresponding flat plate-shaped particle is maximal. Since the aluminum pigment was made by crushing a deposition film, from those having substantially flat surfaces (X-Y plane) and substantially uniform thicknesses (in this embodiment, 20 nm), measurement of the R50 was performed.

Using the aluminum pigment dispersion liquid, an ink C1-1 having a composition shown in Table 3 was prepared. In Table 3, “CAB” represents cellulose acetate butyrate, “γ-BL” represents γ-butyrolactone, and “DEGdEE” represents diethylene glycol diethyl ether. In addition, the unit of Table 3 is mass %.

TABLE 3

| | | | Water-Soluble Organic Solvent | | |
|---|---|---|---|---|---|
| | | Resin | with Intermediate Boiling Point | | |
| | Pigment | CAB | γ-BL | DEGdEE | Total |
| Ink C-1 | 1.5 | 0.1 | 10.0 | 88.4 | 100 |

### Preparation of Adhesive Liquid

The adhesive liquid for adhesive layer formation was prepared.

### Adhesive Liquid 1A

1,2-HD, PG, Polysol AT860 (Tg of 60° C.), BYK-348, and ion-exchange water were mixed, and agitated at 40° C. for 20 minutes, and thereafter the resultant was filtered by a membrane filter having a diameter of 5 μm, thereby preparing an adhesive liquid 1A of which the composition is shown in Table 4.

### Adhesive Liquid 2A

1,2-HD, 2-Py, PG, Vinyblan 2886 (a vinyl acetate-acrylic resin emulsion, trade name produced by Nissin Chemical Industry Co., Ltd., with a Tg of 0° C. and an active ingredient of 43%) as a resin emulsion, BYK-348, and ion-exchange water were mixed, and agitated at 40° C. for 20 minutes, and thereafter the resultant was filtered by a membrane filter having a diameter of 5 μm, thereby preparing an adhesive liquid 2A of which the composition is shown in Table 4.

Adhesive Liquid 3A

Diethylene glycol monobutyl ether, 1,2-HD, 2-Py, PG, Vinyblan 5202 (an acetate-acrylic resin emulsion, trade name produced by Nissin Chemical Industry Co., Ltd., with a Tg of 30° C. and an active ingredient of 40%) as a resin emulsion, BYK-348, Surfynol 465, and ion-exchange water were mixed, and agitated at 40° C. for 20 minutes, and thereafter the resultant was filtered by a membrane filter having a diameter of 5 μm, thereby preparing an adhesive liquid 3A of which the composition is shown in Table 4.

### Adhesive Liquid 4A

1,2-HD, 2-Py, PG, Polysol AP-7020 (a styrene-acrylic resin emulsion, trade name produced by SHOWA DENKO K.K., with an average particle size of 130 nm, Tg of 85° C., and an active ingredient of 50%) as a resin emulsion, BYK-348, and ion-exchange water were mixed, and agitated at 40° C. for 20 minutes, and thereafter the resultant was filtered by a membrane filter having a diameter of 5 μm, thereby preparing an adhesive liquid 4A of which the composition is shown in Table 4.

### Adhesive Liquid 5A

1,2-HD, 2-Py, PG, Vinyblan 2622 (an acrylic resin emulsion, trade names produced by Nissin Chemical Industry Co., Ltd., with Tg of −26° C. and an active ingredient of 48%) as a resin emulsion, BYK-348, and ion-exchange water were mixed, and agitated at 40° C. for 20 minutes, and thereafter the resultant was filtered by a membrane filter having a diameter of 5 μm, thereby preparing an adhesive liquid 5A of which the composition is shown in Table 4.

The compositions of the adhesives 1A to 5A are collected in Table 4. In addition, in Table 4, “Resin EM” means a resin emulsion, and empty fields mean no addition.

TABLE 4

| | | Water-Soluble Organic | | | | | | | |
|---|---|---|---|---|---|---|---|---|---|
| | Resin | Solvent with Intermediate | | | | Surfactant | | Ion- | |
| | Resin | Boiling Point | | | | | Surfynol | Exchange | |
| | EM | DEGmBE | 1,2-HD | 2-Py | PG | BYK-348 | 465 | Water | Total |
| Adhesive | 25 | | 2 | | 8 | 1 | | 64 | 100 |
| Liquid 1 | | | | | | | | | |
| Adhesive | 2.5 | | 20 | 15 | 5 | 1 | | 56.5 | 100 |
| Liquid 2 | | | | | | | | | |
| Adhesive | 8 | 5 | 3 | 5 | 5 | 0.5 | 0.5 | 73 | 100 |
| Liquid 3 | | | | | | | | | |
| Adhesive | 8 | | 5 | 4 | 12 | 1 | | 70 | 100 |
| Liquid 4 | | | | | | | | | |
| Adhesive | 8 | | 5 | 4 | 12 | 1 | | 70 | 100 |
| Liquid 5 | | | | | | | | | |

### Ink Jet Head Discharge Preparation

A discharge experiment on an ink jet head using each of the inks and the adhesive liquids was performed using PX-G5300 (an ink jet printer, produced by Seiko Epson Corporation), and the experiment does not limit the embodiment of the invention.

The ink is put into the ink cartridge for the respective color ink, and the adhesive liquid is put into the ink cartridge of a gloss optimizer to be prepared, and the ink cartridges are mounted in a printer to perform an operation of charging the ink jet head. Thereafter, printing preparation was performed by checking those discharged from the ink jet head.

### Evaluation of Discharge Stability

The discharge stability of the ink and the adhesive liquid by the ink jet head was evaluated. Under an environment with a temperature of 25° C. and a relative humidity of 40% RH, discharge of the ink and the adhesive liquid from the ink jet head was continuously performed. As for the discharge condition, a response frequency of 25 kHz, a resolution of 5760 dpi×1440 dpi, an ink droplet weight of 2 ng, and a 100% duty were set, and so-called solid printing was performed. Here, “duty” is a value calculated by the following expression.

duty(%)=actual printing dot count/(vertical resolution×horizontal resolution)×100

(in the expression, “actual printing dot count” is an actual printing dot count per unit area, and “vertical resolution” and “horizontal resolution” are respectively resolutions per unit area)

The evaluation criteria is as follows.

A: dot omission or flight skewing was not generated even after 15 minutes, or it is recovered by a cleaning operation even though generated within 15 minutes. C: dot omission or flight skewing was generated within 15 minutes and was not recovered even though the cleaning operation was performed.

As the evaluation results, all the inks (A1-1 to A1-5 and B1-1 to B1-6) and all the adhesive liquids (1A to 5A) were evaluated as A. Therefore, it was confirmed that all the prepared inks and the adhesive liquids were excellent in discharge stability.

### Preparation of Base Material of Transfer Medium

### Preparation of Base Material I-A of Transfer Medium

Onto a biaxially-oriented PET film having a width of 600 mm and a thickness of 12 μm in a roll form, a wax which is low-density curable polyethylene (trade name: Hi-Wax 110P produced by Mitsui Chemicals, Inc.) was applied with a thickness of 20 nm to form a release layer. Moreover, a thermosetting melamine resin layer produced from a melamine resin (trade name: Amilac 1000 produced by Kansai Paint Co., Ltd.) was applied with a thickness of 10 nm, and thereafter the resultant was heated and cured at 130° C. for 5 minutes to form a protective layer, thereby producing a base material I-A of the transfer medium in a roll form.

### Preparation of Base Material II-A of Transfer Medium

Onto a biaxially-oriented PET film having a width of 600 mm and a thickness of 16 μm in a roll form, an acrylic resin containing a silicone oil (with a non-volatile content of 45 mass %, trade name: ACRYDIC A-166 produced by DIC Corporation) was applied with a thickness of 50 nm, and the resultant was heated and dried at 150° C. for 10 minutes to form a release layer and a protective layer, thereby producing a base material II-A of the transfer medium in a roll form.

### Preparation of Base Material III-A of Transfer Medium

On a biaxially-oriented PET film having a width of 600 mm and a thickness of 38 μm in a roll form, a discharge treatment was performed for 3 minutes at a distance of 10 mm using Air Plasma APW-602 (a corona treater, trade name produced by Kasuga Electric Works Ltd.) to reform the film surface, thereby producing a base material III-A of the transfer medium.

### Production of Transfer Medium

### Production of Transfer Medium I-A1

The base material I-A of the transfer medium in a roll form was mounted in the transfer medium production apparatus shown in FIG. 1 (here, as shown in FIG. 2, the warm air fan 35 is provided and the second drying unit 50 was not provided). In addition, using a software program for printing, by changing the driving voltage waveform of the piezoelectric element of the head, a resolution of 5760 dpi×1440 dpi was set while appropriately adjusting liquid droplet weights to be in a range of 2 to 10 ng.

First, a colored layer was formed. Heating was performed by the heater of the platen 34 which is the first drying unit from the rear surface of the base material I-A at 50° C., ink was further discharged from the head of the transfer medium production apparatus to be adhered onto the surface of the base material I-A while warm air at 40° C. was blown thereto, and drying was performed under a condition of evaporating 65 mass % of the liquid component contained in the ink. In this manner, the colored layer was formed on the surface of the base material I-A. As such, an image pattern was formed on the base material I-A of the transfer medium.

In the image pattern constituted by the colored layer, the white ink A1-5 was adhered to cover the surface of an image formed by each of the black, cyan, magenta, and yellow inks A1-1, A1-2, A1-3, and A1-4.

Here, each of the inks A1-1, A1-2, A1-3, A1-4, and A1-5 was adhered under the condition set in advance. That is, each of the inks A1-1, A1-2, A1-3, A1-4, and A1-5 was adhered under the condition in which the thickness of the layer measured by microtome-transmission electron microscopy in advance was 1.0 μm at the minimum portion and was 2.0 μm at the maximum portion.

Next, an adhesive layer was formed. The adhesive liquid 1A was discharged from the head to be adhered onto the colored layer. Here, the adhesive liquid 1A was adhered onto the ink-adhered portions at a resolution of 2880 dpi×1440 dpi with a discharge amount of 2 ng. Here, the thickness of the adhesive layer in the discharge condition was measured in advance as 0.5 μm at the minimum portion and 1.5 μm at the maximum portion. Thereafter, the resultant was fed to the second drying unit 50, and while warm air at 80° C. was blown to the surface of the base material I-A, evaporation and drying of the ink and the adhesive liquid 1A were accelerated to form the adhesive layer, thereby producing the transfer medium I-A1. In addition, for the obtained transfer medium I-A1, the evaporation amount of the liquid component contained in the ink and the adhesive liquid 1A was measured from the mass of the base material I-A and the amounts of the ink and the adhesive liquid 1A adhered as 97%.

### Production of Transfer Medium I-A2

Except that the adhesive liquid 2A was used instead of the adhesive liquid 1A, the amount of the adhesive liquid adhered was adjusted to cause an adhesive layer to have a thickness of 1 to 1.5 μm, and drying was performed under the condition of evaporating 95% of the liquid component contained in the ink, a transfer medium I-A2 was produced in the same manner as the case of producing the transfer medium I-A1.

### Production of Transfer Medium I-A3

Except that the adhesive liquid 3A was used instead of the adhesive liquid 1A, the amount of the adhesive liquid adhered was adjusted to cause an adhesive layer to have a thickness of 1.5 to 2 μm, and drying was performed under the condition of evaporating 80% of the liquid component contained in the ink, a transfer medium I-A3 was produced in the same manner as the case of producing the transfer medium I-A1.

### Production of Transfer Medium I-A4

Except that the adhesive liquid 4A was used instead of the adhesive liquid 1A, the amount of the adhesive liquid adhered was adjusted to cause an adhesive layer to have a thickness of 2 to 3 μm, and drying was performed under the condition of evaporating 80% of the liquid component contained in the ink, a transfer medium I-A4 was produced in the same manner as the case of producing the transfer medium I-A1.

### Production of Transfer Medium I-A5

Except that the adhesive liquid 5A was used instead of the adhesive liquid 1A, the amount of the adhesive liquid adhered was adjusted to cause an adhesive layer to have a thickness of 2 to 3 μm, and drying was performed under the condition of evaporating 80% of the liquid component contained in the ink, a transfer medium I-A5 was produced in the same manner as the case of producing the transfer medium I-A1.

### Production of Transfer Medium II-A1

The base material II-A of the transfer medium in a roll form was mounted in the transfer medium production apparatus shown in FIG. 7. In addition, using a software program for printing, by changing the driving voltage waveform of the piezoelectric element of the head, a resolution of 5760 dpi×1440 dpi was set while appropriately adjusting liquid droplet masses to be in a range of 2 to 10 ng.

First, a colored layer was formed. Heating was performed by the heater (the thermal conduction type heating unit 141) of the platen 34 which is the first fixing unit 140 from the rear surface of the base material II-A at 50° C., and ink was further discharged from the head of the transfer medium production apparatus to be adhered onto the surface of the base material II-A while warm air at 40° C. was blown to the surface of the base material II-A. Simultaneously with this, drying was performed under a condition of evaporating 40 mass % of the liquid component excluding solid contents contained therein. Thereafter, the resultant was fed to the second fixing unit 150 and illuminated with UV rays to cure the ink adhered to the base material II-A, thereby forming the colored layer on the surface of the base material II-A. Here, each of the inks B1 to B6 was adhered under the condition set in advance. That is, each of the inks B1-1 to B1-6 was adhered under the condition in which the thickness of the layer measured by microtome-transmission electron microscopy in advance was 3.0 μm at the minimum portion and was 5.0 μm at the maximum portion. In addition, the UV-rays illumination was performed using the D lamps produced by Fusion System as the first to third UV lamps at an illumination intensity of 100 mW/cm² for 10 seconds.

In this manner, an image pattern was formed on the base material II-A of the transfer medium.

Next, an adhesive layer was formed. First, the base material II-A was returned to the first fixing unit 140 from the second fixing unit 150, and the adhesive liquid 1A was discharged from the head to be adhered. Here, the adhesive liquid 1A was adhered onto the ink-adhered portions at a resolution of 2880 dpi×1440 dpi with a discharge amount of 2 ng. Thereafter, the resultant was stopped by the platen 34, warm air at 80° C. was blown onto the base material II-A by the warm air fan 35, and evaporation and drying of the ink and the adhesive liquid 1A were accelerated to form the adhesive layer, thereby producing the transfer medium II-A1.

The thickness of the adhesive layer was adjusted by, as described in paragraphs of the production of the transfer medium I-A1, controlling the amount of the resin emulsion in the adhesive liquid and the amount of the adhesive liquid adhered. During the production of the transfer medium II-A1, the amount of the adhesive liquid adhered was adjusted so that the thickness of the adhesive layer was 1 to 1.5 μm.

### Production of Transfer Medium II-A2

Except that the adhesive liquid 2A was used instead of the adhesive liquid 1A, the amount of the adhesive liquid adhered was adjusted to cause an adhesive layer to have a thickness of 1.5 to 2 μm, and drying was performed under the condition of evaporating 70% of the liquid component contained in the ink, a transfer medium II-A2 was produced in the same manner as the case of producing the transfer medium II-A2.

### Production of Transfer Medium II-A3

Except that the adhesive liquid 3A was used instead of the adhesive liquid 1A, the amount of the adhesive liquid adhered was adjusted to cause an adhesive layer to have a thickness of 2 to 3 μm, and drying was performed under the condition of evaporating 55% of the liquid component contained in the ink, a transfer medium II-A3 was produced in the same manner as the case of producing the transfer medium II-A1.

### Production of Transfer Medium II-A4

Except that the adhesive liquid 4A was used instead of the adhesive liquid 1A, the amount of the adhesive liquid adhered was adjusted to cause an adhesive layer to have a thickness of 2 to 3 μm, and drying was performed under the condition of evaporating 55% of the liquid component contained in the ink, a transfer medium II-A4 was produced in the same manner as the case of producing the transfer medium II-A1.

### Production of Transfer Medium II-A5

Except that the adhesive liquid 5A was used instead of the adhesive liquid 1A, the amount of the adhesive liquid adhered was adjusted to cause an adhesive layer to have a thickness of 2.5 to 3.5 μm, and drying was performed under the condition of evaporating 55% of the liquid component contained in the ink, a transfer medium II-A5 was produced in the same manner as the case of producing the transfer medium II-A1.

### Production of Transfer Medium III-A1

The transfer medium base material I-A was used as a transfer medium.

The base material I-A of the transfer medium in a roll form was mounted in the transfer medium production apparatus shown in FIG. 1 (here, as shown in FIG. 2, the warm air fan 35 was provided and the second drying unit 50 was not provided). In addition, using a software program for printing, by changing the driving voltage waveform of the piezoelectric element of the head, a resolution of 5760 dpi×1440 dpi was set while appropriately adjusting liquid droplet weights to be in a range of 2 to 10 ng.

First, a colored layer was formed. Heating was performed by the heater of the platen 34 which is the first drying unit from the rear surface of the base material I-A at 70° C., ink was further discharged from the head of the transfer medium production apparatus to be adhered to the surface of the base material I-A while warm air at 80° C. was blown thereto, and drying was performed under a condition of evaporating 70 mass % of the liquid component contained in the ink C1-1. In this manner, the colored layer was formed on the surface of the base material I-A. As such, an image pattern was formed on the base material I-A of the transfer medium.

Here, the ink C1-1 was adhered under the condition set in advance. That is, the ink C1-1 was adhered under the condition in which the thickness of the layer measured by microtome-transmission electron microscopy in advance was 50 nm at the minimum portion and was 100 nm at the maximum portion.

Next, an adhesive layer was formed. The adhesive liquid 1A was discharged from the head to be adhered onto the colored layer. Here, the adhesive liquid 1A was adhered onto the ink-adhered portions at a resolution of 2880 dpi×1440 dpi with a discharge amount of 2 ng. Here, the thickness of the adhesive layer in the discharge condition was measured in advance as 1.0 μm at the minimum portion and 2.0 μm at the maximum portion. Thereafter, the resultant was stopped by the platen 34 and sent to the second drying unit 50, warm air at 80° C. was blown to the surface of the base material I-A, and evaporation and drying of the ink and the adhesive liquid 1A were accelerated to form the adhesive layer, thereby producing the transfer medium III-A1. In addition, for the obtained transfer medium III-A1, the evaporation amount of the liquid component contained in the ink and the adhesive liquid 1A was measured from the mass of the base material I-A and the amounts of the ink and the adhesive liquid 1A adhered as 92%.

### Production of Transfer Medium III-A2

Except that the adhesive liquid 2A was used instead of the adhesive liquid 1A and drying was performed under the condition of evaporating 90% of the liquid component contained in the ink, a transfer medium III-A2 was produced in the same manner as the case of producing the transfer medium I-A1.

### Production of Transfer Medium III-A3

Except that the adhesive liquid 3A was used instead of the adhesive liquid 1A and drying was performed under the condition of evaporating 70% of the liquid component contained in the ink, a transfer medium III-A3 was produced in the same manner as the case of producing the transfer medium I-A1.

### Production of Transfer Medium III-A4

Except that the adhesive liquid 4A was used instead of the adhesive liquid 1A and drying was performed under the condition of evaporating 70% of the liquid component contained in the ink, a transfer medium III-A4 was produced in the same manner as the case of producing the transfer medium I-A1.

### Production of Transfer Medium III-A5

Except that the adhesive liquid 5A was used instead of the adhesive liquid 1A and drying was performed under the condition of evaporating 70% of the liquid component contained in the ink, a transfer medium III-A5 was produced in the same manner as the case of producing the transfer medium I-A1.

### Production of Transfer Medium IV-A1

The base material III-A of the transfer medium in a roll form was mounted in the transfer medium production apparatus shown in FIG. 7. In addition, using a software program for printing, by changing the driving voltage waveform of the piezoelectric element of the head, a resolution of 5760 dpi×1440 dpi was set while appropriately adjusting liquid droplet weights to be in a range of 2 to 10 ng.

First, a colored layer was formed. Heating was performed by the heater (the thermal conduction type heating unit 141) of the platen 34 which is the first fixing unit 140 from the rear surface of the base material III-A at 50° C., and ink was further discharged from the head of the transfer medium production apparatus to be adhered to the surface of the base material III-A while warm air at 40° C. was blown to the surface of the base material III-A. Simultaneously with this, drying was performed under a condition of evaporating 55 mass % of the liquid component excluding solid contents contained therein. Thereafter, the resultant was fed to the second fixing unit 150 and illuminated with UV rays to cure the ink adhered to the base material III-A, thereby forming the colored layer on the surface of the base material III-A. Here, each of the inks B1 to B6 was adhered under the condition set in advance. That is, each of the inks B1-1 to B1-6 was adhered under the condition in which the thickness of the layer measured by microtome-transmission electron microscopy in advance was 3.0 μm at the minimum portion and was 5.0 μm at the maximum portion. In addition, the UV-rays illumination was performed using the D lamps produced by Fusion System as the first to third UV lamps at an illumination intensity of 100 mW/cm² for 10 seconds.

In this manner, an image pattern was formed on the base material III-A of the transfer medium.

Next, an adhesive layer was formed. First, the base material III-A was returned to the first fixing unit 140 from the second fixing unit 150, and the adhesive liquid 3A was discharged from the head to be adhered. Here, the adhesive liquid 3A was adhered onto the ink-adhered portions at a resolution of 2880 dpi×1440 dpi with a discharge amount of 2 ng. Thereafter, the resultant was stopped by the platen 34, warm air at 80° C. was blown onto the base material III-A by the warm air fan 35, and evaporation and drying of the ink and the adhesive liquid 1A were accelerated to form the adhesive layer, thereby producing the transfer medium IV-A1.

The thickness of the adhesive layer was adjusted by, as described in paragraphs of the production of the transfer medium I-A1, controlling the amount of the resin emulsion in the adhesive liquid and the amount of the adhesive liquid adhered. During the production of the transfer medium IV-A1, the amount of the adhesive liquid adhered was adjusted so that the thickness of the adhesive layer was 1.5 to 2.5 μm.

### Evaluation Items

### Evaluation of Printing Resolution

Printing resolution was evaluated. The evaluation criteria are as follows. The evaluation results are shown in Tables 5 to 7 as follows. A: an image of 5 points (characters; MS Ming style, em hiragana) was able to be clearly read. C: an image of 5 points (characters; MS Ming style, em hiragana) was not able to be read.

### Transferability Evaluation

A transfer medium which is subjected to a slit process into a width of 100 mm was mounted in a hot stamping machine R415F-TP (trade name produced by Amagasaki Machinery Co., Ltd., a roll-on type) at a predetermined position, and a medium to be transferred was transferred onto an acrylic resin plate at a thermocompression bonding roller temperature of 150° C., a pressure of 30 kg/cm², and a speed of 20 cm/sec.

The evaluation criteria are as follows. The evaluation results are shown in Tables 5 to 7 as follows:

AA: an image of 4 points (characters; MS Ming style, em hiragana) could be completely transferred.

A: although transfer of an image of 4 points (characters; MS Ming style, em hiragana) was incomplete, an image of 6 points (characters; MS Ming style, em hiragana) could be completely transferred.

C: transfer of an image of 6 points (characters; MS Ming style, em hiragana) was incomplete.

### Adhesiveness Evaluation

A grid tape peeling test was performed on colored layers on acrylic resin plates transferred in the transferability evaluation on the basis of JIS D0202-1988. After a cellophane tape (registered trade mark) (CT24 (trade name) produced by Nichiban Co., Ltd.) was pressed against the colored layer with the ball of a finger, the cellophane tape was peeled. Evaluation was performed by showing the number of cells in which the colored layer was not peeled from among 100 cells. That is, a case where the colored layer was not peeled at all was evaluated as “100/100”, and a case where the colored layer was completely peeled was evaluated as “0/100”. The evaluation criteria are as follows. The evaluation results are shown in Tables 5 to 7 as follows. A: less than 30/100. C: equal to or more than 30/100.

### Blocking Resistance Evaluation

Each of the transfer media (I-A and II-A) in which the colored layer and the adhesive layer were formed into a length of 20 m was wound around a paper tube with φ3 inches by a winder. Next, each transfer medium after winding was left at 40° C. for 1 week, and winding-out performance of each transfer medium was evaluated.

The evaluation was performed on the basis of whether or not a phenomenon (blocking) in which an adhesive component such as a thermoplastic resin had stuck to the contact surface (PET rear surface) and the transfer medium could not be wound out, or the colored layer or the adhesive layer remained on the PET rear surface even though the transfer medium was wound out, was generated. The evaluation criteria are as follows. The evaluation results are shown in Tables 5 to 7 as follows. A: not generated. C: generated.

TABLE 5

| No. | 1 | 2 | 3 | 4 | 5 |
|---|---|---|---|---|---|
| Ink | A-1, 2, | A-1, 2, | A-1, 2, | A-1, 2, | A-1, 2, |
| | 3, 4, 5 | 3, 4, 5 | 3, 4, 5 | 3, 4, 5 | 3, 4, 5 |
| Adhesive Liquid | 1 | 2 | 3 | 4 | 5 |
| Thickness of Colored | 2 to | 2 to | 2 to | 2 to | 2 to |
| Layer | 4 μm | 4 μm | 4 μm | 4 μm | 4 μm |
| Thickness of Adhesive | 0.5 to | 1 to | 1.5 to | 2 to | 2 to |
| Layer | 1.5 μm | 1.5 μm | 2 μm | 3 μm | 3 μm |
| Tg of Resin EM | 60° C. | 0° C. | 30° C. | 85° C. | −30° C. |
| Printing Resolution | A | A | A | A | A |
| Transferability | AA | AA | AA | C | A |
| Adhesiveness | A | A | A | C | A |
| Blocking Resistance | A | A | A | A | C |

TABLE 6

| No. | 6 | 7 | 8 | 9 | 10 |
|---|---|---|---|---|---|
| Ink | B-1, 2, | B-1, 2, | B-1, 2, | B-1, 2, | B-1, 2, |
| | 3, 4, | 3, 4, | 3, 4, | 3, 4, | 3, 4, |
| | 5, 6 | 5, 6 | 5, 6 | 5, 6 | 5, 6 |
| Adhesive Liquid | 1 | 2 | 3 | 4 | 5 |
| Thickness of Colored | 3 to | 3 to | 3 to | 3 to | 3 to |
| Layer | 5 μm | 5 μm | 5 μm | 5 μm | 5 μm |
| Thickness of Adhesive | 1 to | 1.5 to | 2 to | 2 to | 2.5 to |
| Layer | 1.5 μm | 2 μm | 3 μm | 3 μm | 3.5 μm |
| Tg of Resin EM | 60° C. | 0° C. | 30° C. | 85° C. | −30° C. |
| Printing Resolution | A | A | A | A | A |
| Transferability | AA | AA | AA | C | A |
| Adhesiveness | A | A | A | C | A |
| Blocking Resistance | A | A | A | A | C |

TABLE 7

| No. | 11 | 12 | 13 | 14 | 15 | 16 |
|---|---|---|---|---|---|---|
| Ink | C-1 | C-1 | C-1 | C-1 | C-1 | B-1, 2, 3, 4, 5, 6 |
| Adhesive Liquid | 1 | 2 | 3 | 4 | 5 | 3 |
| Thickness | 50 to 100 nm | 50 to 100 nm | 50 to 100 nm | 50 to 100 nm | 50 to 100 nm | 3 to 5 μm |
| of Colored | | | | | | |
| Layer | | | | | | |
| Thickness | 1 to 2 μm | 1 to 2 μm | 1 to 2 μm | 1 to 2 μm | 1 to 2 μm | 1.5 to 2.5 μm |
| of Adhesive | | | | | | |
| Layer | | | | | | |
| Tg of Resin EM | 60° C. | 30° C. | 0° C. | 85° C. | −30° C. | 30° C. |
| Printing | A | A | A | A | A | A |
| Resolution | | | | | | |
| Transferability | AA | AA | AA | C | A | — |
| Adhesiveness | A | A | A | C | A | A |
| Blocking | A | A | A | A | C | A |
| Resistance | | | | | | |

In addition, the reason why there is no evaluation result of the transferability of No. 16 is that a sticking film of which the base material remains on a transferred matter unlike a transfer film was used.

From the results of Tables 5 to 7, it was found that as the aqueous liquids (see Nos. 4 and 9 and Nos. 5 and 10) containing thermoplastic resins in emulsion forms of which the glass-transition temperatures of equal to or higher than 0° C. and equal to or lower than 60° C. were used as the adhesive liquids, discharge stability when the inks for colored layer formation and the adhesive liquids for adhesive layer formation were discharged from the ink jet head was excellent, so that the patterns of the colored layers with high resolution were obtained and transferability of the transfer media, adhesiveness after transfer, and blocking resistance were excellent.

### Example B

### Preparation of Aqueous Pigment Ink A2

Aqueous pigment inks A2 for colored layer formation (hereinafter, simply referred to as “ink A2”) were prepared.

### Ink A2-1

4 parts by mass of diethylene glycol monobutyl ether (hereinafter, also referred to as “DEGBE”), 1 parts by mass of BYK-348 (a silicone-based surfactant, trade name produced by BYK-Chemie Japan K.K.), and 30 parts by mass of ion-exchange water were mixed, and agitated at room temperature for 20 minutes, thereby obtaining a preliminary mixed liquid. Next, 5 parts by mass of JONCRYL 678 (an acrylic water-soluble resin, trade name produced by BASF, with a molecular weight of 8500, and an acid number of 215) as a water-soluble resin, and 0.1 parts by mass of potassium hydroxide (KOH) as a pH-adjuster were added to the preliminary mixed liquid, and the resultant was agitated at 40° C. for 1 hour.

To the liquid after the agitation, 10 parts by mass of carbon black MA100 (trade name produced by Mitsubishi Chemical Corporation) was added to obtain a mixed liquid, and the mixed liquid is agitated together with zirconia glass beads (with a diameter of 1.5 mm) having a mass of 1.5 times the mass of the mixed liquid in a desktop sand mill (produced by Hayashi Shoten) at 2160 rpm for 2 hours so as to be dispersed. After the dispersion, the resultant was filtered by a SUS mesh filter with a diameter of 0.1 mm, thereby preparing a dispersion liquid.

To the dispersion liquid, 2-pyrrolidone (hereinafter, also referred to as “2-Py”), propylene glycol (hereinafter, also referred to as “PG”), Polysol AM-710 (an acrylic resin emulsion, trade name produced by SHOWA DENKO K.K., with an average particle size of 150 nm and an active ingredient of 50.5%) as a resin emulsion, Proxel-XL2 (a preservative, trade name produced by Arch Chemicals), and ion-exchange water were added by amounts (parts by mass) shown in Table 8, and the resultant was agitated at 40° C. for 20 minutes. After the agitation, the resultant was filtered by a membrane filter having a diameter of 5 μm, thereby preparing a black ink A2-1 of which the composition is shown in Table 8.

### Ink A2-2

4 parts by mass of DEGBE, 0.5 parts by mass of BYK-348, and 30 parts by mass of ion-exchange water were mixed, and agitated at room temperature for 20 minutes, thereby obtaining a preliminary mixed liquid. Next, 2 parts by mass of JONCRYL 680 (an acrylic water-soluble resin, trade name produced by BASF, with a molecular weight of 4900, and an acid number of 215) as a water-soluble resin, and 0.1 mass % of KOH were added to the preliminary mixed liquid, and the resultant was agitated at 40° C. for 1 hour.

To the liquid after the agitation, 5 parts by mass of a cyan pigment (C.I. Pigment Blue 15:3, produced by DIC Corporation) was added to obtain a mixed liquid, and thereafter, the resultant was subjected to dispersion and filtration under the same conditions as those of the case of the ink A2-1, thereby preparing a dispersion liquid.

To the dispersion liquid, 1,2-hexanediol (hereinafter, also referred to as “1,2-HD”), 2-Py, PG, Polysol AM-2300 (a styrene-acrylic resin emulsion, trade name produced by SHOWA DENKO K.K., with a minimum film forming temperature (MFT) of 70° C., an average particle size of 90 nm, and an active ingredient of 40%) as a resin emulsion, Proxel-XL2, and ion-exchange water were added by amounts (parts by mass) shown in Table 8, and thereafter, the resultant was agitated and filtered under the same conditions as those of the case of the ink A2-1, thereby preparing a cyan ink A2-2 of which the composition is shown in Table 8.

### Ink A2-3

3 parts by mass of DEGBE, 0.8 parts by mass of BYK-348, and 30 parts by mass of ion-exchange water were mixed, and agitated at room temperature for 20 minutes, thereby obtaining a preliminary mixed liquid. Next, 1 part by mass of JONCRYL 680 and 0.1 mass % of KOH were added to the preliminary mixed liquid, and the resultant was agitated at 40° C. for 1 hour.

To the liquid after the agitation, 4 parts by mass of a magenta pigment (C.I. Pigment Red 122, produced by BASF) was added to obtain a mixed liquid, and thereafter, the resultant was subjected to dispersion and filtration under the same conditions as those of the case of the ink A2-1, thereby preparing a dispersion liquid.

To the dispersion liquid, 1,2-HD, 2-Py, PG, AE373D (a styrene-acrylic resin emulsion, trade name produced by JSR, with an average particle size of 150 nm, and an active ingredient of 50%), Proxel-XL2, and ion-exchange water were added by amounts (parts by mass) shown in Table 8, and thereafter, the resultant was agitated and filtered under the same conditions as those of the case of the ink A2-1, thereby preparing a magenta ink A2-3 of which the composition is shown in Table 8.

### Ink A2-4

3 parts by mass of DEGBE, 0.8 parts by mass of BYK-348, and 30 parts by mass of ion-exchange water were mixed, and agitated at room temperature for 20 minutes, thereby obtaining a preliminary mixed liquid. Next, 2 parts by mass of JONCRYL 680 and 0.1 mass % of KOH were added to the preliminary mixed liquid, and the resultant was agitated at 40° C. for 1 hour.

To the liquid after the agitation, 4 parts by mass of a yellow pigment (C.I. Pigment Yellow 180, produced by Dainichiseika Color & Chemicals Mfg. Co., Ltd.) was added to obtain a mixed liquid, and thereafter, the resultant was subjected to dispersion and filtration under the same conditions as those of the case of the ink A2-1, thereby preparing a dispersion liquid.

To the dispersion liquid, 1,2-HD, 2-Py, PG, Polysol AT860 (an acrylic resin emulsion, trade name produced by SHOWA DENKO K.K., with an average particle size of 120 nm, Tg of 60° C., and an active ingredient of 50%) as a resin emulsion, Surfynol 465 (an acetylene glycol-based surfactant, trade name produced by Air Products and Chemicals Inc.), Proxel-XL2, and ion-exchange water were added by amounts (parts by mass) shown in Table 8, and thereafter, the resultant was agitated and filtered under the same conditions as those of the case of the ink A2-1, thereby preparing a yellow ink A2-4 of which the composition is shown in Table 8.

### Ink A2-5

1 part by mass of BYK348, 4.7 parts by mass of Denka POVAL H-12 (polyvinyl alcohol, trade name produced by Denki Kagaku Kogyo K.K., a pure content of 94%) as a water-soluble resin, and 30 parts by mass of ion-exchange water were mixed, and agitated at 40° C. for 1 hour.

To the liquid after the agitation, 9.5 parts by mass of CR-50 (rutile type titanium oxide, trade name produced by ISHIHARA SANGYO KAISHA, LTD., with a TiO₂ active ingredient of 95%, and an average particle size of 0.25 μm) as a pigment was added to obtain a mixed liquid, and thereafter, the resultant was subjected to dispersion and filtration under the same conditions as those of the case of the ink A2-1, thereby preparing a dispersion liquid.

To the dispersion liquid, Takelac W-6061, (a polyurethane resin emulsion, trade name produced by Mitsui Chemicals, Inc., with a solid content of 30%), 1,2-HD, 2-Py, PG, Proxel-XL2, and ion-exchange water were added by amounts (parts by mass) shown in Table 8, and the resultant was agitated at 40° C. for 20 minutes. After the agitation, the resultant was filtered by a SUS mesh filter with a diameter of 10 μm, thereby preparing a white ink A2-5 of which the composition is shown in Table 8.

The compositions of the ink A2-1 to the ink A2-5 are collected in Table 8. In addition, in Table 8, “Resin EM” means a resin emulsion, and empty fields mean no addition. The molecular weight of ion-exchange water is the molecular weight of the ion-exchange water contained in the obtained ink.

TABLE 8

| | | Resin | | Water-Soluble Organic | | | | | | | | | |
|---|---|---|---|---|---|---|---|---|---|---|---|---|---|
| | | Water- | | Solvent with Intermediate | | | | Surfactant | | pH- | | Ion- | |
| | | Soluble | Resin | Boiling Point | | | | BYK- | Surfynol | adjuster | Preservative | Exchange | |
| | Pigment | Resin | EM | DEGBE | 1,2-HD | 2-Py | PG | 348 | 465 | KOH | Proxel-XL2 | water | Total |
| Ink | 10 | 5 | 0.5 | 4 | | 4 | 1 | 1 | | 0.1 | 0.2 | 74.2 | 100 |
| A-1 | | | | | | | | | | | | | |
| Ink | 5 | 2 | 13 | 3 | 4 | 3 | 12 | 0.5 | | 0.1 | 0.2 | 57.2 | 100 |
| A-2 | | | | | | | | | | | | | |
| Ink | 4 | 1 | 0.5 | 3 | 4 | 3 | 12 | 0.8 | | 0.1 | 0.2 | 71.4 | 100 |
| A-3 | | | | | | | | | | | | | |
| Ink | 4 | 2 | 0.6 | 3 | 10 | 5 | 5 | 0.8 | 1.2 | 0.1 | 0.2 | 68.1 | 100 |
| A-4 | | | | | | | | | | | | | |
| Ink | 9.5 | 4.7 | 4 | | 5 | 4 | 5 | 1 | | | 0.2 | 66.6 | 100 |
| A-5 | | | | | | | | | | | | | |

### Preparation of UV-Curable Pigment Ink B2

UV-curable pigment inks B2 for colored layer formation (hereinafter, simply referred to as “ink B2”) were prepared.

### Ink B2-1

14 parts by mass of allyl glycol (a monomer produced by Nippon Nyukazai Co., Ltd., hereinafter, also referred to as “AG”) and 1.2 parts by mass of Discole N-509 (a dispersant, polyoxyalkylene polyalkylene polyamine, trade name produced by Dainichiseika Color & Chemicals Mfg. Co., Ltd.) were mixed, and agitated at 40° C. for 20 minutes.

To the liquid after the agitation, 6 parts by mass of carbon black MA7 (trade name produced by Mitsubishi Chemical Corporation) was added to obtain a mixed liquid, and the mixed liquid is agitated together with zirconia glass beads (with a diameter of 1.5 mm) having a mass of 1.5 times the mass of the mixed liquid in a desktop sand mill (produced by Hayashi Shoten) at 2160 rpm for 2 hours so as to be dispersed. After the dispersion, the resultant is filtered by a SUS mesh filter with a diameter of 0.1 mm, thereby preparing a dispersion liquid.

To the dispersion liquid, N-methyl-2-pyrrolidone (hereinafter, also referred to as “NMP”), U-15HA (a urethane acrylate oligomer, trade name produced by Shin-Nakamura Chemical Co., Ltd., with a weight-average molecular weight of 2300), Irgacure 127 and 819 (a photopolymerization initiator, hereinbefore, trade names produced by BASF), Irgastab UV-10 (a polymerization inhibitor, trade name produced by BASF), BYK-UV3500 (a surfactant, trade name produced by BYK-Chemie Japan K.K.), and AG (residue) were added by amounts (parts by mass) shown in Table 9, and the resultant was agitated at room temperature for 1 hour. After the agitation, the resultant was filtered by a membrane filter having a diameter of 5 μm, thereby preparing a black ink B2-1 of which the composition is shown in Table 9. In addition, in 10 parts by mass of the photopolymerization initiator in Table 9, there are 7 parts by mass of Irgacure 127 and 3 parts by mass of Irgacure 819.

### Ink B2-2

A dispersion liquid was prepared in the same manner as during the preparation of the ink B2-1 except that carbon black which is a colorant was used as a cyan pigment (C.I. Pigment Blue 15:4, produced by DIC Corporation) and the composition was as shown in FIG. 9. In addition, during preparation of this dispersion liquid, 14 parts by mass of AG was added.

To the dispersion liquid, N-vinylformamide (hereinafter, also referred to as “NVF”) as a monomer, U-15HA, Irgacure 127 and 819, Irgastab UV-10, BYK-UV3500, and AG (residue) were added by amounts (parts by mass) shown in Table 9, and the resultant was agitated at room temperature for 1 hour. After the agitation, the resultant was filtered by a membrane filter having a diameter of 5 μm, thereby preparing a cyan ink B2-2 of which the composition is shown in Table 9. In addition, in 69.8 parts by mass of the monomer in Table 9, there are 59.8 parts by mass of AG and 10 parts by mass of NVF. In addition, in 5 parts by mass of the photopolymerization initiator in Table 9, there are 3 parts by mass of Irgacure 127 and 2 parts by mass of Irgacure 819.

### Ink B2-3

A dispersion liquid was prepared in the same manner as during the preparation of the ink B2-1 except that carbon black which is a colorant was used as a magenta pigment (C.I. Pigment Violet 19, produced by BASF) and the composition was as shown in FIG. 9. In addition, during preparation of this dispersion liquid, 14 parts by mass of AG was added.

To the dispersion liquid, 2-Py, U-15HA, Irgacure 127 and 819, Irgastab UV-10, BYK-UV3500, AG (residue), and ion-exchange water were added by amounts (parts by mass) shown in Table 9, and the resultant was agitated at room temperature for 1 hour. After the agitation, the resultant was filtered by a membrane filter having a diameter of 5 μm, thereby preparing a magenta ink B2-3 of which the composition is shown in Table 9. In addition, in 3 parts by mass of the photopolymerization initiator in Table 9, there are 2 parts by mass of Irgacure 127 and 1 parts by mass of Irgacure 819.

### Ink B2-4

A dispersion liquid was prepared in the same manner as during the preparation of the ink B2-1 except that carbon black which is a colorant was used as a yellow pigment (C.I. Pigment Yellow 150, produced by Win chemicals Ltd.) and the composition was as shown in FIG. 9. In addition, during preparation of this dispersion liquid, 14 parts by mass of AG was added.

To the dispersion liquid, 2-Py, U-15 HA, Irgacure 127 and 819, Irgastab UV-10, BYK-UV3500, and AG (residue) were added by amounts (parts by mass) shown in Table 9, and the resultant was agitated at room temperature for 1 hour. After the agitation, the resultant was filtered by a membrane filter having a diameter of 5 μm, thereby preparing a yellow ink B2-4 of which the composition is shown in Table 9. In addition, in 5 parts by mass of the photopolymerization initiator in Table 9, there are 3 parts by mass of Irgacure 127 and 2 parts by mass of Irgacure 819.

### Ink B2-5

A dispersion liquid was prepared in the same manner as during the preparation of the ink B2-1 except that carbon black which is a colorant was used as a cyan pigment (C.I. Pigment Blue 15:4, produced by DIC Corporation) and the composition was as shown in FIG. 9. In addition, during preparation of this dispersion liquid, 14 parts by mass of AG was added.

To the dispersion liquid, N-vinylformamide

(hereinafter, also referred to as “NVF”) as a monomer, U-15HA, Irgacure 127 and 819, Irgastab UV-10, BYK-UV3500, and AG (residue) were added by amounts (parts by mass) shown in Table 9, and the resultant was agitated at room temperature for 1 hour. After the agitation, the resultant was filtered by a membrane filter having a diameter of 5 μm, thereby preparing a light cyan ink B1-2 of which the composition is shown in Table 9. In addition, in 44.4 parts by mass of the monomer in Table 9, there are 34.4 parts by mass of AG and 10 parts by mass of NVF. In addition, in 5 parts by mass of the photopolymerization initiator in Table 9, there are 3 parts by mass of Irgacure 127 and 2 parts by mass of Irgacure 819.

### Ink B2-6

A dispersion liquid was prepared in the same manner as during the preparation of the ink B2-1 except that carbon black which is a colorant was used as a magenta pigment (C.I. Pigment Violet 19, produced by BASF) and the composition was as shown in FIG. 9. In addition, during preparation of this dispersion liquid, 14 parts by mass of AG was added.

To the dispersion liquid, 2-Py, U-15HA, Irgacure 127 and 819, Irgastab UV-10, BYK-UV3500, AG (residue), and ion-exchange water were added by amounts (parts by mass) shown in Table 9, and the resultant was agitated at room temperature for 1 hour. After the agitation, the resultant was filtered by a membrane filter having a diameter of 5 μm, thereby preparing a magenta ink B2-6 of which the composition is shown in Table 9. In addition, in 3 parts by mass of the photopolymerization initiator in Table 9, there are 2 parts by mass of Irgacure 127 and 1 part by mass of Irgacure 819.

The compositions of the ink B2-1 to the ink B2-6 are collected in Table 2. In addition, in Table 9, the molecular weight of a monomer is the molecular weight of a monomer contained in the obtained ink. Empty fields mean no addition.

TABLE 9

| | | | | Water-Soluble Organic | | | | | | | |
|---|---|---|---|---|---|---|---|---|---|---|---|
| | | Polymerizable | | Solvent with Intermediate | | | | Polymerization | | Ion- | |
| | | Compound | | Boiling Point | | Dispersant | Surfactant | Inhibitor | Photopolymerization | Exchange | |
| | Pigment | Monomer | Oligomer | NMP | 2-Py | N-509 | UV3500 | UV-10 | Initiator | water | Total |
| Ink | 6 | 42.4 | 20 | 20 | | 1.2 | 0.2 | 0.2 | 10 | | 100 |
| B-1 | | | | | | | | | | | |
| Ink | 4 | 69.8 | 20 | | | 0.8 | 0.2 | 0.2 | 5 | | 100 |
| B-2 | | | | | | | | | | | |
| Ink | 5 | 70 | 10.6 | | 7 | 1 | 0.2 | 0.2 | 3 | 3 | 100 |
| B-3 | | | | | | | | | | | |
| Ink | 10 | 62.6 | 10 | | 10 | 2 | 0.2 | 0.2 | 5 | | 100 |
| B-4 | | | | | | | | | | | |
| Ink | 0.2 | 44.4 | 50 | | | 0.04 | 0.2 | 0.2 | 5 | | 100 |
| B-5 | | | | | | | | | | | |
| Ink | 0.5 | 30 | 50 | | 7 | 0.1 | 0.2 | 0.2 | 3 | 9 | 100 |
| B-6 | | | | | | | | | | | |

### Preparation of Adhesive Liquid

The adhesive liquid for adhesive layer formation was prepared.

### Adhesive Liquid 1B

1,2-HD, PG, Polysol AT860, BYK-348, and ion-exchange water were mixed, and agitated at 40° C. for 20 minutes, and thereafter the resultant was filtered by a membrane filter having a diameter of 5 μm, thereby preparing an adhesive liquid 1B of which the composition is shown in Table 10.

### Adhesive Liquid 2B

1,2-HD, 2-Py, PG, AE-120A (an acrylic resin emulsion, trade name produced by JSR, with an average particle size of 55 nm and an active ingredient of 36.5%) as a resin emulsion, BYK-348, and ion-exchange water were mixed, and agitated at 40° C. for 20 minutes, and thereafter the resultant was filtered by a membrane filter having a diameter of 5 μm, thereby preparing an adhesive liquid 2B of which the composition is shown in Table 10.

### Adhesive Liquid 3B

Diethylene glycol monobutyl ether (hereinafter, also referred to as “DEGmBE”), 1,2-HD, 2-Py, PG, Polysol SH-502 (a polyvinyl acetate resin emulsion, trade names produced by SHOWA DENKO K.K., with an average particle size of 950 nm, Tg of 30° C., and an active ingredient of 50.3%) as a resin emulsion, BYK-348, Surfynol 465, and ion-exchange water were mixed, and agitated at 40° C. for 20 minutes, and thereafter the resultant was filtered by a membrane filter having a diameter of 5 μm, thereby preparing an adhesive liquid 3B of which the composition is shown in Table 10.

### Adhesive Liquid 4B

1,2-HD, 2-Py, PG, Seikadain 1900W (an ethylene-vinyl acetate resin emulsion, trade name produced by Dainichiseika Color & Chemicals Mfg. Co., Ltd., with an average particle size of 1.1 μm and an active ingredient of 50%) as a resin emulsion, BYK-348, and ion-exchange water were mixed, and agitated at 40° C. for 20 minutes, and thereafter the resultant was filtered by a membrane filter having a diameter of 5 μm, thereby preparing an adhesive liquid 4B of which the composition is shown in Table 10.

The compositions of the adhesives 1B to 4B are collected in Table 10. In addition, in Table 10, “Resin EM” means a resin emulsion, and empty fields mean no addition.

TABLE 10

| | | | Water-Soluble Organic | | | | | | |
|---|---|---|---|---|---|---|---|---|---|
| | Resin | Organic | Solvent with Intermediate | | | Surfactant | | Ion- | |
| | Resin | Solvent | Boiling Point | | | BYK- | Surfynol | Exchange | |
| | EM | DEGmBE | 1,2-HD | 2-Py | PG | 348 | 465 | Water | Total |
| Adhesive | 25 | | 2 | | 8 | 1 | | 64 | 100 |
| Liquid 1 | | | | | | | | | |
| Adhesive | 2.5 | | 20 | 15 | 5 | 1 | | 56.5 | 100 |
| Liquid 2 | | | | | | | | | |
| Adhesive | 8 | 5 | 3 | 5 | 5 | 0.5 | 0.5 | 73 | 100 |
| Liquid 3 | | | | | | | | | |
| Adhesive | 8 | | 5 | 4 | 12 | 1 | | 70 | 100 |
| Liquid 4 | | | | | | | | | |

### Ink Jet Head Discharge Preparation

A discharge experiment on an ink jet head using each of the inks and the adhesive liquids was performed using PX-G5300 (an ink jet printer, produced by Seiko Epson Corporation), and the experiment does not limit the embodiment of the invention.

The ink is put into the ink cartridge for the respective color ink, and the adhesive liquid is put into the ink cartridge of a gloss optimizer to be prepared, and the ink cartridges are mounted in a printer to perform an operation of charging the ink jet head. Thereafter, printing preparation was performed by checking those discharged from the ink jet head.

### Evaluation of Discharge Stability

The discharge stability of the ink and the adhesive liquid by the ink jet head was evaluated. Under an environment with a temperature of 25° C. and a relative humidity of 40% RH, discharge of the ink and the adhesive liquid from the ink jet head was continuously performed. As for the discharge condition, a response frequency of 25 kHz, a resolution of 5760 dpi×1440 dpi, an ink droplet weight of 2 ng, and a 100% duty were set, and so-called solid printing was performed. Here, “duty” is a value calculated by the following expression.

duty(%)=actual printing dot count/(vertical resolution×horizontal resolution)×100

(in the expression, “actual printing dot count” is an actual printing dot count per unit area, and “vertical resolution” and “horizontal resolution” are respectively resolutions per unit area)

The evaluation criteria are as follows. A: dot omission or flight skewing was not generated even after 15 minutes, or it is recovered by a cleaning operation even though generated within 15 minutes. C: dot omission or flight skewing was generated within 15 minutes and was not recovered even though the cleaning operation was performed.

As the evaluation results, all the inks (A2-1 to A2-5 and B2-1 to B2-6) and all the adhesive liquids (B1 to B4) were evaluated as A. Therefore, it was confirmed that all the prepared inks and the adhesive liquids were excellent in discharge stability.

### Preparation of Base Material of Transfer Medium

### Preparation of Base Material I-B of Transfer Medium

Onto a biaxially-oriented PET film having a width of 600 mm and a thickness of 12 μm in a roll form, a wax which is low-density curable polyethylene (trade name: Hi-Wax 110P produced by Mitsui Chemicals, Inc.) was applied with a thickness of 20 nm to form a release layer. Moreover, a thermosetting melamine resin layer produced from a melamine resin (trade name: Amilac 1000 produced by Kansai Paint Co., Ltd.) was applied with a thickness of 10 nm, and thereafter the resultant was heated and cured at 130° C. for 5 minutes to form a protective layer, thereby producing a base material I-B of the transfer medium in a roll form.

### Preparation of Base Material II-B of Transfer Medium

Onto a biaxially-oriented PET film having a width of 600 mm and a thickness of 16 μm in a roll form, an acrylic resin containing a silicone oil (with a non-volatile content of 45 mass %, trade name: ACRYDIC A-166 produced by DIC Corporation) was applied with a thickness of 50 nm, and the resultant was heated and dried at 150° C. for 10 minutes to form a release layer and a protective layer, thereby producing a base material II-B of the transfer medium in a roll form.

### Preparation of Base Material III-B of Transfer Medium

On a biaxially-oriented PET film having a width of 600 mm and a thickness of 38 μm in a roll form, a discharge treatment was performed for 3 minutes at a distance of 10 mm using Air Plasma APW-602 (a corona treater, trade name produced by Kasuga Electric Works Ltd.) to reform the film surface, thereby producing a base material III-B of the transfer medium.

### Production of Transfer Medium

### Production of Transfer Medium I-B1

The base material I-B of the transfer medium in a roll form was mounted in the transfer medium production apparatus shown in FIG. 1 (here, as shown in FIG. 2, the warm air fan 35 is provided and the second drying unit 50 was not provided). In addition, using a software program for printing, by changing the driving voltage waveform of the piezoelectric element of the head, a resolution of 5760 dpi×1440 dpi was set while appropriately adjusting liquid droplet weights to be in a range of 2 to 10 ng.

First, a colored layer was formed. Heating was performed by the heater of the platen 23 which is the first drying unit from the rear surface of the base material I-B at 50° C., ink was further discharged from the head of transfer medium production apparatus to be adhered onto the surface of the base material I-B while warm air at 40° C. was blown thereto, and drying was performed under a condition of evaporating 65 mass % of the liquid component contained in the ink and excluding a solid content. In this manner, the colored layer was formed on the surface of the base material I-B. As such, an image pattern was formed on the base material I-B of the transfer medium.

In the image pattern constituted by the colored layer, the white ink A2-5 was adhered to cover the surface of an image formed by each of the black, cyan, magenta, and yellow inks A2-1, A2-2, A2-3, and A2-4.

Here, each of the inks A2-1, A2-2, A2-3, A2-4, and A2-5 was adhered under the condition set in advance. That is, each of the inks A2-1, A2-2, A2-3, A2-4, and A2-5 was adhered under the condition in which the thickness of the layer measured by microtome-transmission electron microscopy in advance was 1.0 μm at the minimum portion and was 2.0 μm at the maximum portion.

Next, an adhesive layer was formed. The adhesive liquid 1B was discharged from the head to be adhered onto the colored layer. Here, the adhesive liquid 1B was adhered onto the ink-adhered portions at a resolution of 2880 dpi×1440 dpi with a discharge amount of 2 ng. Here, the thickness of the adhesive layer in the discharge condition was measured in advance as 0.5 μm at the minimum portion and 1.5 μm at the maximum portion. Thereafter, the resultant was fed to the second drying unit 50, and while warm air at 80° C. was blown to the surface of the base material I-B, evaporation and drying of the ink and the adhesive liquid 1B were accelerated to form the adhesive layer, thereby producing the transfer medium I-B1. In addition, for the obtained transfer medium I-1, the evaporation amount of the liquid component contained in the ink and the adhesive liquid 1B was measured from the mass of the base material I-B and the amounts of the ink and the adhesive liquid 1B adhered as 97%.

### Production of Transfer Medium I-B2

Except that the adhesive liquid 2B was used instead of the adhesive liquid 1B, the amount of the adhesive liquid adhered was adjusted to cause an adhesive layer to have a thickness of 0.5 to 1 μm, and drying was performed under the condition of evaporating 95% of the liquid component contained in the ink, a transfer medium I-B2 was produced in the same manner as the case of producing the transfer medium I-B1.

### Production of Transfer Medium I-B3

Except that the adhesive liquid 3B was used instead of the adhesive liquid 1B, the amount of the adhesive liquid adhered was adjusted to cause an adhesive layer to have a thickness of 1 to 1.5 μm, and drying was performed under the condition of evaporating 80% of the liquid component contained in the ink, a transfer medium I-B3 was produced in the same manner as the case of producing the transfer medium I-B1.

### Production of Transfer Medium I-B4

Except that the amount of the adhesive liquid adhered was adjusted to cause an adhesive layer to have a thickness of 5 to 6 μm and drying was performed under the condition of evaporating 80% of the liquid component contained in the ink, a transfer medium I-B4 was produced in the same manner as the case of producing the transfer medium I-B1.

### Production of Transfer Medium I-B5

Except that the adhesive liquid 4B was used instead of the adhesive liquid 1B and drying was performed under the condition of evaporating 80% of the liquid component contained in the ink, a transfer medium I-B5 was produced in the same manner as the case of producing the transfer medium I-B1.

### Production of Transfer Medium II-B1

The base material II-B of the transfer medium in a roll form was mounted in the transfer medium production apparatus shown in FIG. 7. In addition, using a software program for printing, by changing the driving voltage waveform of the piezoelectric element of the head, a resolution of 5760 dpi×1440 dpi was set while appropriately adjusting liquid droplet masses to be in a range of 2 to 10 ng.

First, a colored layer was formed. Heating was performed by the heater (the thermal conduction type heating unit 141) of the platen 34 which is the first fixing unit 140 from the rear surface of the base material II-B at 50° C., and ink was further discharged from the head of the transfer medium production apparatus to be adhered onto the surface of the base material II-B while warm air at 40° C. was blown to the surface of the base material II-B. Simultaneously with this, drying was performed under a condition of evaporating 40 mass % of the liquid component excluding solid contents contained therein. Thereafter, the resultant was fed to the second fixing unit 150 and illuminated with UV rays to cure the ink adhered to the base material II-B, thereby forming the colored layer on the surface of the base material II-B. Here, each of the inks B1 to B6 was adhered under the condition set in advance. That is, each of the inks B1 to B6 was adhered under the condition in which the thickness of the layer measured by microtome-transmission electron microscopy in advance was 3.0 μm at the minimum portion and was 5.0 μm at the maximum portion. In addition, the UV-rays illumination was performed using the D lamps produced by Fusion System as the first to third UV lamps at an illumination intensity of 100 mW/cm² for 10 seconds.

In this manner, an image pattern was formed on the base material II-B of the transfer medium.

Next, an adhesive layer was formed. First, the adhesive liquid 1B was discharged from the head to be adhered. Here, the adhesive liquid 1B was adhered onto the ink-adhered portions at a resolution of 2880 dpi×1440 dpi with a discharge amount of 2 ng. Thereafter, the resultant was stopped by the platen 34, warm air at 80° C. was blown onto the base material II-B by the warm air fan 35, and evaporation and drying of the ink and the adhesive liquid 1B were accelerated to form the adhesive layer, thereby producing the transfer medium II-B1.

The thickness of the adhesive layer was adjusted by, as described in paragraphs of the production of the transfer medium I-B1, controlling the amount of the resin emulsion in the adhesive liquid and the amount of the adhesive liquid adhered. During the production of the transfer medium II-B1, the amount of the adhesive liquid adhered was adjusted so that the thickness of the adhesive layer was 1 to 1.5 μm.

### Production of Transfer Medium II-B2

Except that the adhesive liquid 2B was used instead of the adhesive liquid 1B, the amount of the adhesive liquid adhered was adjusted to cause an adhesive layer to have a thickness of 0.5 to 1 μm, and drying was performed under the condition of evaporating 70% of the liquid component contained in the ink, a transfer medium II-B2 was produced in the same manner as the case of producing the transfer medium II-B2.

### Production of Transfer Medium II-B3

Except that the adhesive liquid 3B was used instead of the adhesive liquid 1B, the amount of the adhesive liquid adhered was adjusted to cause an adhesive layer to have a thickness of 1 to 1.5 μm, and drying was performed under the condition of evaporating 55% of the liquid component contained in the ink, a transfer medium II-B3 was produced in the same manner as the case of producing the transfer medium II-B1.

### Production of Transfer Medium II-B4

Except that the amount of the adhesive liquid adhered was adjusted to cause an adhesive layer to have a thickness of 6 to 7 μm and drying was performed under the condition of evaporating 55% of the liquid component contained in the ink, a transfer medium II-B4 was produced in the same manner as the case of producing the transfer medium II-B1.

### Production of Transfer Medium II-B5

Except that the adhesive liquid 4B was used instead of the adhesive liquid 1B and drying was performed under the condition of evaporating 55% of the liquid component contained in the ink, a transfer medium II-B5 was produced in the same manner as the case of producing the transfer medium II-B1.

### Production of Transfer Medium III-B1

The base material III-B of the transfer medium in a roll form was mounted in the transfer medium production apparatus shown in FIG. 7. In addition, using a software program for printing, by changing the driving voltage waveform of the piezoelectric element of the head, a resolution of 5760 dpi×1440 dpi was set while appropriately adjusting liquid droplet masses to be in a range of 2 to 10 ng.

First, a colored layer was formed. Heating was performed by the heater (the thermal conduction type heating unit 141) of the platen 34 which is the first fixing unit 140 from the rear surface of the base material III-B at 50° C., and ink was further discharged from the head of the transfer medium production apparatus to be adhered onto the surface of the base material III-B while warm air at 40° C. was blown to the surface of the base material III-B. Simultaneously with this, drying was performed under a condition of evaporating 55 mass % of the liquid component excluding solid contents contained therein. Thereafter, the resultant was fed to the second fixing unit 150 and illuminated with UV rays to cure the ink adhered to the base material III-B, thereby forming the colored layer on the surface of the base material III-B. Here, each of the inks B1 to B6 was adhered under the condition set in advance. That is, each of the inks B1 to B6 was adhered under the condition in which the thickness of the layer measured by microtome-transmission electron microscopy in advance was 3.0 μm at the minimum portion and was 5.0 μm at the maximum portion. In addition, the UV-rays illumination was performed using the D lamps produced by Fusion System as the first to third UV lamps at an illumination intensity of 100 mW/cm² for 10 seconds.

In this manner, an image pattern was formed on the base material III-B of the transfer medium.

Next, an adhesive layer was formed. First, the base material III-B was returned to the first fixing unit 140 from the second fixing unit 150, and the adhesive liquid 3B was discharged from the head to be adhered. Here, the adhesive liquid 3B was adhered onto the ink-adhered portions at a resolution of 2880 dpi×1440 dpi with a discharge amount of 2 ng. Thereafter, the resultant was stopped by the platen 34, warm air at 80° C. was blown onto the base material III-B by the warm air fan 35, and evaporation and drying of the ink and the adhesive liquid 3B were accelerated to form the adhesive layer, thereby producing the transfer medium III-B1.

The thickness of the adhesive layer was adjusted by, as described in paragraphs of the production of the transfer medium I-B1, controlling the amount of the resin emulsion in the adhesive liquid and the amount of the adhesive liquid adhered. During the production of the transfer medium III-B1, the amount of the adhesive liquid adhered was adjusted so that the thickness of the adhesive layer was 1.5 to 2.5 μm.

### Evaluation Items

### Evaluation of Printing Resolution

Printing resolution was evaluated. The evaluation criteria are as follows. The evaluation results are shown in Tables 11 to 13 as follows. A: an image of 5 points (characters; MS Ming style, em hiragana) was able to be clearly read. C: an image of 5 points (characters; MS Ming style, em hiragana) was not able to be read.

### Transferability Evaluation

A transfer medium which is subjected to a slit process into a width of 100 mm was mounted in a hot stamping machine R415F-TP (trade name produced by Amagasaki Machinery Co., Ltd., a roll-on type) at a predetermined position, and a medium to be transferred was transferred onto an acrylic resin plate at a thermocompression bonding roller temperature of 150° C., a pressure of 30 kg/cm², and a speed of 20 cm/sec.

The evaluation criteria are as follows. The evaluation results are shown in Tables 11 to 13 as follows.

AA: an image of 4 points (characters; MS Ming style, em hiragana) could be completely transferred.

A: although transfer of an image of 4 points (characters; MS Ming style, em hiragana) was incomplete, an image of 6 points (characters; MS Ming style, em hiragana) could be completely transferred.

C: transfer of an image of 6 points (characters; MS Ming style, em hiragana) was incomplete.

### Adhesiveness Evaluation

A grid tape peeling test was performed on colored layers on acrylic resin plates transferred in the transferability evaluation on the basis of JIS D0202-1988. After a cellophane tape (registered trade mark) (CT24 (trade name) produced by Nichiban Co., Ltd.) was pressed against the colored layer with the ball of a finger, the cellophane tape was peeled. Evaluation was performed by showing the number of cells in which the colored layer was not peeled from among 100 cells. That is, a case where the colored layer was not peeled at all was evaluated as “100/100”, and a case where the colored layer was completely peeled was evaluated as “0/100”. The evaluation criteria are as follows. The evaluation results are shown in Tables 11 to 13 as follows. A: less than 30/100. C: equal to or more than 30/100.

TABLE 11

| No. | 1 | 2 | 3 | 4 | 5 |
|---|---|---|---|---|---|
| Ink | A-1, 2, | A-1, 2, | A-1, 2, | A-1, 2, | A-1, 2, |
| | 3, 4, 5 | 3, 4, 5 | 3, 4, 5 | 3, 4, 5 | 3, 4, 5 |
| Adhesive Liquid | 1 | 2 | 3 | 1 | 4 |
| Thickness of Colored | 2 to | 2 to | 2 to | 2 to | 2 to |
| Layer | 4 μm | 4 μm | 4 μm | 4 μm | 4 μm |
| Thickness of Adhesive | 1 to | 0.5 to | 1 to | 5 to | 1 to |
| Layer | 1.5 μm | 1 μm | 1.5 μm | 6 μm | 1.5 μm |
| Tg of Resin EM | 60° C. | 0° C. | 30° C. | 60° C. | 85° C. |
| Printing Resolution | A | A | A | A | A |
| Transferability | AA | AA | AA | A | A |
| Adhesiveness | A | A | A | A | A |

TABLE 12

| No. | 6 | 7 | 8 | 9 | 10 |
|---|---|---|---|---|---|
| Ink | B-1, 2, | B-1, 2, | B-1, 2, | B-1, 2, | B-1, 2, |
| | 3, 4, | 3, 4, | 3, 4, | 3, 4, | 3, 4, |
| | 5, 6 | 5, 6 | 5, 6 | 5, 6 | 5, 6 |
| Adhesive Liquid | 1 | 2 | 3 | 1 | 4 |
| Thickness of Colored | 3 to | 3 to | 3 to | 3 to | 3 to |
| Layer | 5 μm | 5 μm | 5 μm | 5 μm | 5 μm |
| Thickness of Adhesive | 1 to | 0.5 to | 1 to | 6 to | 1 to |
| Layer | 1.5 μm | 1 μm | 1.5 μm | 7 μm | 1.5 μm |
| Tg of Resin EM | 60° C. | 0° C. | 30° C. | 85° C. | −30° C. |
| Printing Resolution | A | A | A | A | A |
| Transferability | AA | AA | AA | C | A |
| Adhesiveness | A | A | A | C | A |

TABLE 13

| No. | 11 |
|---|---|
| Ink | B-1, 2, 3, 4, 5, 6 |
| Adhesive Liquid | 3 |
| Thickness of Colored Layer | 3 to 5 μm |
| Thickness of Adhesive Layer | 1.5 to 2.5 μm |
| Tg of Resin EM | 30° C. |
| Printing Resolution | A |
| Transferability | — |
| Adhesiveness | A |
| Blocking Resistance | A |

In addition, the reason why there is no evaluation result of the transferability of No. 27 is that a sticking film of which the base material remains on a transferred matter unlike a transfer film was used.

From the results of Tables 11 to 13, it was found that as the aqueous liquids (see Nos. 21 and 26) containing thermoplastic resins in emulsion forms of which the average particle sizes are smaller than 1 μm were used as the adhesive liquids and the thicknesses of the adhesive layers were adjusted to be smaller than the thicknesses of the colored layers (see Nos. 20 and 25), discharge stability when the inks for colored layer formation and the adhesive liquids for adhesive layer formation were discharged from the ink jet head was excellent, the patterns of the colored layers could be obtained with high resolution, transferability was excellent, and adhesiveness after transfer was excellent.

What is claimed is:

1. A production method of a transfer medium comprising:
forming a colored layer on a base material by discharging ink from an ink jet head toward the base material; and
forming an adhesive layer on the colored layer by discharging an adhesive liquid from the ink jet head toward the colored layer,
wherein the adhesive liquid is an aqueous liquid containing a thermoplastic resin in an emulsion form having a glass-transition temperature of equal to or higher than 0° C. and equal to or lower than 60° C.

2. The production method according to claim 1, wherein the ink is an aqueous pigment ink, a non-aqueous pigment ink, or a UV-curable pigment ink.

3. The production method according to claim 1, wherein the forming of the colored layer includes evaporating a liquid component contained in the ink discharged and adhered to the base material so as to satisfy the following (1), (2), or (3):
(1) in a case where the ink is the aqueous pigment ink, 65 to 95 mass % of the liquid component contained in the ink is evaporated,
(2) in a case where the ink is the non-aqueous pigment ink, 50 to 90 mass % of the liquid component contained in the ink is evaporated,
(3) in a case where the ink is the UV-curable pigment ink, 40 to 70 mass % of the liquid component contained in the ink is evaporated.

4. The production method according to claim 1,
wherein the aqueous pigment ink or the non-aqueous pigment ink from among the inks contains a water-soluble organic solvent having a boiling point of equal to or higher than 70° C. and equal to or lower than 250° C. at 1 atm, and
the water-soluble organic solvent is an aqueous liquid containing one or more kinds selected from the group consisting of lactam, carboxylic acid ester, alkylene glycol ether, and alcohol.

5. The production method according to claim 1,
wherein the adhesive liquid contains a water-soluble organic solvent having a boiling point of equal to or higher than 70° C. and equal to or lower than 250° C. at 1 atm, and
the water-soluble organic solvent is an aqueous liquid containing one or more kinds selected from the group consisting of lactam, carboxylic acid ester, alkylene glycol ether, and alcohol.

6. The production method according to claim 1, wherein the base material is metal, plastic, or paper.

7. A transfer medium obtained by the production method according to claim 1.

8. A transferred matter obtained by transferring the transfer medium according to claim 7 onto a medium to be transferred.

9. A production method of a transfer medium comprising:
forming a colored layer on a base material by discharging ink from an ink jet head toward the base material; and
forming an adhesive layer on the colored layer by discharging an adhesive liquid from the ink jet head toward the colored layer,
wherein the adhesive liquid is an aqueous liquid containing a thermoplastic resin in an emulsion form having an average particle size of smaller than 1 μm, and
a thickness of the adhesive layer is smaller than a thickness of the colored layer.

10. The production method according to claim 9, wherein the ink is an aqueous pigment ink, a non-aqueous pigment ink, or a UV-curable pigment ink.

11. The production method according to claim 9, wherein the forming of the colored layer includes evaporating a liquid component contained in the ink discharged and adhered to the base material so as to satisfy the following (1), (2), or (3):
(1) in a case where the ink is the aqueous pigment ink, 65 to 95 mass % of the liquid component contained in the ink is evaporated,
(2) in a case where the ink is the non-aqueous pigment ink, 50 to 90 mass % of the liquid component contained in the ink is evaporated,
(3) in a case where the ink is the UV-curable pigment ink, 40 to 70 mass % of the liquid component contained in the ink is evaporated.

12. The production method according to claim 9,
wherein the aqueous pigment ink or the non-aqueous pigment ink from among the inks contains a water-soluble organic solvent having a boiling point of equal to or higher than 70° C. and equal to or lower than 250° C. at 1 atm, and
the water-soluble organic solvent is an aqueous liquid containing one or more kinds selected from the group consisting of lactam, carboxylic acid ester, alkylene glycol ether, and alcohol.

13. The production method according to claim 9,
wherein the adhesive liquid contains a water-soluble organic solvent having a boiling point of equal to or higher than 70° C. and equal to or lower than 250° C. at 1 atm, and
the water-soluble organic solvent is an aqueous liquid containing one or more kinds selected from the group consisting of lactam, carboxylic acid ester, alkylene glycol ether, and alcohol.

14. The production method according to claim 9, wherein the base material is metal, plastic, or paper.

15. A transfer medium obtained by the production method according to claim 9.

16. A transferred matter obtained by transferring the transfer medium according to claim 15 onto a medium to be transferred.

17. The production method according to claim 1,
wherein the adhesive liquid is an aqueous liquid containing a thermoplastic resin in an emulsion form having an average particle size of smaller than 1 μm, and
a thickness of the adhesive layer is smaller than a thickness of the colored layer.
